(19) United States
(12) Patent Application Publication
(10) Pub. No.: US 2014/0374260 A1
(43) Pub. Date: Dec. 25, 2014

(54) TWO-DIMENSIONAL ELECTROPHORESIS KIT, METHOD FOR MANUFACTURING TWO-DIMENSIONAL ELECTROPHORESIS KIT, TWO-DIMENSIONAL ELECTROPHORESIS METHOD, AND TWO-DIMENSIONAL ELECTROPHORESIS CHIP

(71) Applicant: Sharp Kabushiki Kaisha, Osaka-shi, Osaka (JP)

(72) Inventors: Hiroshi Ohki, Osaka-shi (JP); Tsuyoshi Tanaka, Osaka-shi (JP); Hiroshi Yamaki, Osaka-shi (JP); Yoshiyuki Ishida, Osaka-shi (JP); Yutaka Unuma, Osaka-shi (JP); Yuji Maruo, Osaka-shi (JP)

(73) Assignee: Sharp Kabushiki Kaisha, Osaka-shi, Osaka (JP)

(21) Appl. No.: 14/376,716

(22) PCT Filed: Feb. 6, 2013
(86) PCT No.: PCT/JP2013/052739

§ 371 Date: Aug. 5, 2014

(30) Foreign Application Priority Data
Feb. 7, 2012 (JP) 2012-024439
Feb. 8, 2012 (JP) 2012-025556

(51) Int. Cl. G01N 27/447

(52) U.S. Cl. CPC G01N 27/44773; G01N 27/44795
USPC 204/610; 427/58

(57) ABSTRACT

With intent to increase the number of sample spots separated through two-dimensional electrophoresis and to enhance the intensity in detection of the spots, a two-dimensional electrophoresis kit includes a first medium 7 for first dimensional electrophoresis, a second medium 8 for second dimensional electrophoresis, and a casing 20 that contains at least the first medium 7 and the second medium 8, wherein the first medium 7 is formed by supplying, to the casing 20, a first solution containing a sample on which the first dimensional electrophoresis is to be performed, and the first medium 7 and the second medium 8 are contained close to each other.

### TECHNICAL FIELD

The present invention relates to a two-dimensional electrophoresis kit, a method for manufacturing the two-dimensional electrophoresis kit, a two-dimensional electrophoresis method, and a two-dimensional electrophoresis chip.

The present application claims priority based on Japanese Patent Application No. 2012-024439 filed in the Japan Patent Office on Feb. 7, 2012 and Japanese Patent Application No. 2012-025556 filed in the Japan Patent Office on Feb. 8, 2012, the entire contents of which are incorporated herein by reference.

### BACKGROUND ART

PTL 1 discloses a two-dimensional electrophoresis method including a step of preparing a two-dimensional electrophoresis substrate formed of one support substrate on which a first electrophoresis resolving medium (IPG gel) in a dried state and a second electrophoresis resolving medium (SDS-PAGE) are supported with a spacing between them, a step of swelling the first electrophoresis resolving medium and impregnating the first electrophoresis resolving medium with a sample, a step of performing primary separation of components in the sample, supplying a liquid buffer to flow through a gap between the first electrophoresis resolving medium and the second electrophoresis resolving medium, and gelling the liquid buffer to connect the first electrophoresis resolving medium and the second electrophoresis resolving medium by a generated gel, and a step of performing secondary separation of the components, which have been subjected to the primary separation, in the second electrophoresis resolving medium.

In molecular biology and biochemistry, electrophoresis is widely employed as a technique for separating biological macromolecules, such as DNA and proteins.

Recently, a proteome analysis has received attention in post-genome researches. The proteome analysis implies a large-scale study focusing on structures and functions of proteins. In the case of carrying out the proteome analysis, a sample containing a plurality of proteins is usually first separated into individual proteins. At that time, two-dimensional electrophoresis is frequently used as one of techniques for separating the proteins.

The two-dimensional electrophoresis is a technique for two-dimensionally separating proteins through two-step electrophoresis. For example, in first dimensional electrophoresis, proteins are separated depending on individual electric charges by employing IEF (isoelectric focusing). In second dimensional electrophoresis, proteins are separated depending on individual molecular weights by employing sodium dodecyl sulfate-polyacrylamide gel electrophoresis (SDS-PAGE).

The two-dimensional electrophoresis has a very high resolution and is able to separate several thousands or more types of proteins with a high resolution. It is known that, particularly, the first dimensional electrophoresis gel takes a great role in separation of proteins related to diseases and so on.

For example, PTL 2 discloses a sample separation instrument for use in the two-dimensional electrophoresis. PTL 2 states that a sample is introduced to a first dimensional electrophoresis gel in the sample separation instrument, the first dimensional electrophoresis gel being in a dried state.

### CITATION LIST

### Patent Literature

PTL 1: Japanese Unexamined Patent Application Publication No. 2006-162405 (Laid-open: Jun. 22, 2006)

PTL 2: Japanese Unexamined Patent Application Publication No. 2007-064848 (Laid-open: Mar. 15, 2007)

### SUMMARY OF INVENTION

### Technical Problem

In molecular biology and biochemistry, electrophoresis is widely employed as a technique for separating biological macromolecules, such as DNA and proteins.

Recently, a proteome analysis has received attention in post-genome researches. The proteome analysis implies a large-scale study focusing on structures and functions of proteins. In the case of carrying out the proteome analysis, a sample containing a plurality of proteins is usually first separated into individual proteins. At that time, two-dimensional electrophoresis is frequently used as one of techniques for separating the proteins.

The two-dimensional electrophoresis is a technique for two-dimensionally separating proteins through two-step electrophoresis. For example, in first dimensional electrophoresis, proteins are separated depending on individual electric charges by employing IEF (isoelectric focusing). In second dimensional electrophoresis, proteins are separated depending on individual molecular weights by employing sodium dodecyl sulfate-polyacrylamide gel electrophoresis (SDS-PAGE).

The two-dimensional electrophoresis has a very high resolution and is able to separate several thousands or more types of proteins with a high resolution. In general, an IPG (immobilized pH gradient) gel is used as the first dimensional electrophoresis gel. The immobilized pH gradient gel is a gel to separate a sample by utilizing the difference in isoelectric point among sample components, and a pH gradient is formed in the gel. The SDS-PAGE gel is used as a second dimensional electrophoresis gel. The SDS-PAGE gel is made up of a concentrating gel to concentrate the sample such that start points of sample separation are matched with each other, and a separating gel to separate the sample depending on a difference in molecular weight.

In the two-dimensional electrophoresis disclosed in PTL 1, however, when surface treatment of the support substrate is not appropriate, wetting of the liquid buffer supplied to flow through the gap between the IPG gel and the SDS-PAGE gel is poor. As a result, the IPG gel and the SDS-PAGE gel are not sufficiently connected to each other by the gel resulting from gelling the liquid buffer in some cases. This raises the problem that the number of sample spots obtained after the second dimensional electrophoresis is small and the intensity in detection of the spots is low.

The present invention has been accomplished in view of the problems described above, and an object of the present invention is to provide a two-dimensional electrophoresis kit, a method for manufacturing the two-dimensional electrophoresis kit, a two-dimensional electrophoresis method, and a two-dimensional electrophoresis chip, which can generate a larger number of sample spots obtained after the second dimensional electrophoresis, and which can enhance the intensity in detection of the spots.

Generally, the first dimensional electrophoresis gel is commercialized in a wet state in many cases. However, several hours are required to introduce a sample to the first dimensional electrophoresis gel in such a state.

Furthermore, when a sample is introduced to the first dimensional electrophoresis gel disclosed in PTL 2, a problem occurs in that, because of the necessity of absorbing the sample into the dried gel, a time is taken to introduce the sample, and sample introduction efficiency is not so high.

In view of the problems described above, a main object of the present invention is to provide a method of preparing an isoelectric focusing gel, the method being able to increase sample introduction efficiency.

### Solution to Problem

According to one aspect of the present invention, there is provided a two-dimensional electrophoresis kit comprising a first medium for first dimensional electrophoresis, a second medium for second dimensional electrophoresis, and a casing that contains at least the first medium and the second medium, wherein the first medium is formed by supplying, to the casing, a first solution containing a sample on which the first dimensional electrophoresis is to be performed, and the first medium and the second medium are contained close to each other.

The two-dimensional electrophoresis kit according to one aspect of the present invention further comprises a connecting medium that is contacted with the first medium and the second medium, and that allows movement of the sample to the second medium.

The two-dimensional electrophoresis kit according to one aspect of the present invention further comprises a first buffer solution storage arranged to supply a buffer solution into the casing from side including the first medium, and a second buffer solution storage arranged to supply a buffer solution into the casing from side including the second medium, wherein the first buffer solution storage, the first medium, the connecting medium, the second medium, and the second buffer solution storage are arrayed parallel to a bottom surface of the casing in mentioned order.

In the two-dimensional electrophoresis kit according to one aspect of the present invention, the first medium is an immobilized pH gradient gel, the second medium is a separating gel of sodium dodecyl sulfate-polyacrylamide, and the connecting medium is a concentrating gel of sodium dodecyl sulfate-polyacrylamide.

In the two-dimensional electrophoresis kit according to one aspect of the present invention, the first medium is an immobilized pH gradient gel, and the second medium is a gradient gel given with a monomer concentration gradient.

In the two-dimensional electrophoresis kit according to one aspect of the present invention, the casing is subjected to surface treatment that enables at least one of the first medium, the second medium, and the connecting medium to be attached to a desired region of the casing.

In the two-dimensional electrophoresis kit according to one aspect of the present invention, the surface treatment is selected from a group consisting of nitration treatment, sulfonation treatment, hydrophilic polymer coating treatment, graft polymer coating treatment, microdot forming treatment, nanodot forming treatment, and oxygen plasma treatment.

The two-dimensional electrophoresis kit according to one aspect of the present invention further comprises voltage applying means to apply voltages to the first medium and the second medium.

According to one aspect of the present invention, there is provided a two-dimensional electrophoresis kit including an isoelectric focusing gel to perform isoelectric focusing of a sample, the kit comprising a storage region where an isoelectric focusing gel solution obtained by adding a gel forming material to a sample-containing solution, which contains the sample, is stored, and electrodes arranged to perform the isoelectric focusing of the sample in the isoelectric focusing gel resulting from gelling the isoelectric focusing gel solution.

According to one aspect of the present invention, there is provided a method for manufacturing a two-dimensional electrophoresis kit, the method comprising at least a first step of forming a first medium by supplying, to a casing, a first solution containing a sample on which first dimensional electrophoresis is to be performed; and a second step of supplying, to the casing, a second medium to perform second dimensional electrophoresis and forming the second medium, wherein the first step and the second step are executed to form the first medium and the second medium such that the first medium and the second medium are close to each other.

The method for manufacturing the two-dimensional electrophoresis kit according to one aspect of the present invention further comprises a third step of forming a connecting medium that is contacted with the first medium and the second medium, and that allows movement of the sample to the second medium.

In the method for manufacturing the two-dimensional electrophoresis kit according to one aspect of the present invention, the first solution is an immobilized pH gradient gel solution, a second solution to form the second medium is a separating gel solution of sodium dodecyl sulfate-polyacrylamide, and a connecting solution to form the connecting medium is a concentrating gel solution of sodium dodecyl sulfate-polyacrylamide.

In the method for manufacturing the two-dimensional electrophoresis kit according to one aspect of the present invention, the first solution, the second solution, and the connecting solution are applied by employing ink jet means.

In the method for manufacturing the two-dimensional electrophoresis kit according to one aspect of the present invention, the first solution is an immobilized pH gradient gel solution, and a second solution to form the second medium is a gradient gel solution.

According to one aspect of the present invention, there is provided a two-dimensional electrophoresis chip comprising a first medium for first dimensional electrophoresis, a second medium for second dimensional electrophoresis, and a casing that contains at least the first medium and the second medium, wherein the first medium is formed by supplying, to the casing, a first solution containing a sample on which the first dimensional electrophoresis is to be performed, and the first medium and the second medium are contained close to each other.

### Advantageous Effects of Invention

With the two-dimensional electrophoresis kit according to one aspect of the present invention, since the bottom surface of the casing for containing the first medium and the second medium is subjected to surface treatment adapted for (i) supplying, to desired regions of the bottom surface, the first solution to form the first medium and the second solution to form the second medium, and (ii) attaching the first medium and the second medium to the desired regions, connection between the first medium and the second medium on the bottom surface of the casing is strengthened. Therefore, the number of sample spots moving from the first medium to the second medium can be increased, and the intensity in detection of the spots can be improved.

The two-dimensional electrophoresis kit according to one aspect of the present invention has the advantageous effect that the first medium can be prepared with higher efficiency in introducing the sample.

With the method for manufacturing the two-dimensional electrophoresis kit according to one aspect of the present invention, a time required from the start of the preparation of the first medium to the end of the first dimensional electrophoresis can be shortened.

### BRIEF DESCRIPTION OF DRAWINGS

FIG. 1 is a schematic view illustrating a two-dimensional electrophoresis kit according to one embodiment of the present invention.

FIG. 2 is a schematic view illustrating a casing in a state before forming a gel.

FIG. 3 is a schematic view to explain a method for manufacturing the two-dimensional electrophoresis kit according to the one embodiment of the present invention.

FIG. 4 is a schematic view to explain a method for manufacturing a two-dimensional electrophoresis kit according to another embodiment of the present invention.

FIG. 5 is a side sectional view to explain a gelling step to prepare an isoelectric focusing gel according to one embodiment of the present invention.

FIG. 6 is a perspective view to explain the gelling step to prepare the isoelectric focusing gel according to the one embodiment of the present invention.

FIG. 7 is a side sectional view to explain a step of preparing an isoelectric focusing gel and a second dimensional electrophoresis gel according to one embodiment of the present invention.

FIG. 8 is a perspective view to explain a step of preparing the isoelectric focusing gel and the second dimensional electrophoresis gel according to the one embodiment of the present invention.

### DESCRIPTION OF EMBODIMENTS

Embodiments of the present invention will be described in detail below.

### First Embodiment

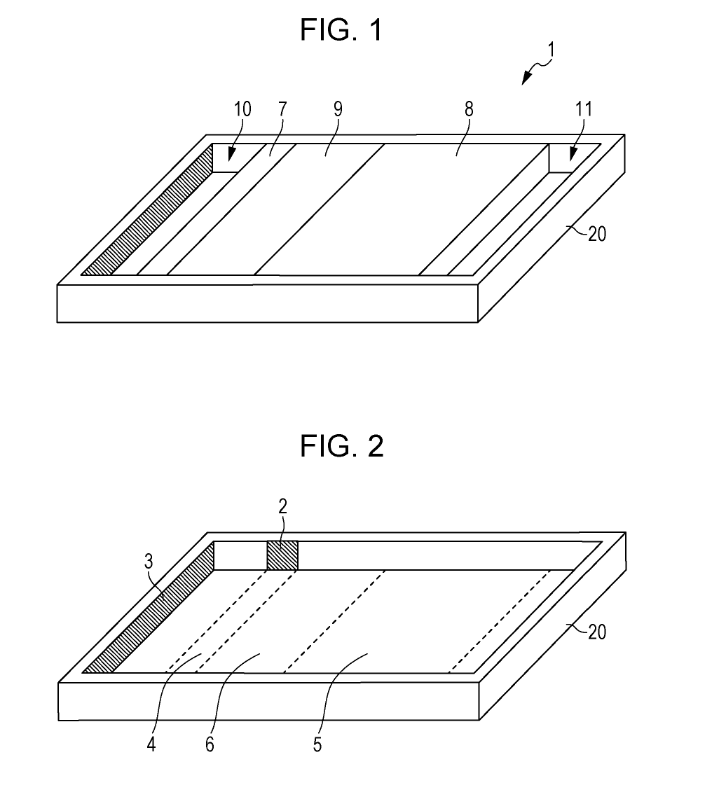

A two-dimensional electrophoresis kit according to one embodiment of the present invention, a method for manufacturing the two-dimensional electrophoresis kit, and a two-dimensional electrophoresis method using the two-dimensional electrophoresis kit will be described below with reference to FIGS. 1 and 2. FIG. 1 is a schematic view illustrating the two-dimensional electrophoresis kit according to the one embodiment of the present invention, and FIG. 2 is a schematic view illustrating a casing in a state before forming a gel.

[Two-Dimensional Electrophoresis Kit]

As illustrated in FIGS. 1 and 2, a two-dimensional electrophoresis kit 1 includes a casing 20, a first gel (first medium) 7, and a second gel (second medium) 8. The two-dimensional electrophoresis kit 1 may further include a connecting gel (connecting medium) 9, a first buffer solution storage 10, and a second buffer solution storage 11.

The two-dimensional electrophoresis kit 1 is a kit used to separate biological macromolecules, such as proteins, DNA (Deoxyribonucleic acid) or RNA (Ribonucleic acid), through two-dimensional electrophoresis. The two-dimensional electrophoresis is a technique for separating biological macromolecules, such as proteins, through two-step electrophoresis, thus enabling the biological macromolecules to be separated more finely.

(Casing 20)

The casing 20 is a container that contains the first gel 7, the second gel 8, and the connecting gel 9, and it serves as a support base for supporting those gels. The casing 20 may be in the form of a box opened in at least one surface to contain the gels therein. The opened surface may be closed by a cover.

A bottom surface of the casing 20, which is contacted with the first gel 7, the second gel 8, and the connecting gel 9 all contained in the casing 20, is subjected to surface treatment adapted for making the first gel 7, the second gel 8, and the connecting gel 9 properly contained in the casing. The bottom surface of the casing 20 is partitioned into a first region 4, a second region 5, and a connecting region 6. As illustrated in FIG. 1, the first gel 7 is formed on the first region 4, the second gel 8 is formed on the second region 5, and the connecting gel 9 is formed on the connecting region 6, respectively. Those gels are each attached to the corresponding region.

A material of the casing 20 is not limited to particular one insofar as the material is able to contain the gels for the two-dimensional electrophoresis. The material of the casing 20 may be selected, for example, from among plastic materials such as a polymethyl methacrylate (PMMA) resin, polyethylene terephthalate (PET), and polycarbonate (PC), glass materials such as soda-lime glass and borosilicate glass, and ceramic materials such as aluminum oxide (Al₂O₃), zirconia oxide (ZrO₂), aluminum nitride (AlN), and silicon carbide (SiC). As one example, the casing 20 may be an injection molded product made of PMMA and having dimensions of 70 mm×55 mm with a thickness of 1 mm.

The casing 20 further includes electrodes 2 and 3 (voltage applying means) for applying voltages to the first gel 7, the second gel 8, and the connecting gel 9 contained therein. As illustrated in FIG. 2, the electrode 2 is disposed in each of lateral surfaces of the casing 20, which intersect the first region 4. Thus, the pair of electrodes 2 are disposed to face each other on both sides of the first gel 7 that is attached to the first region 4. Furthermore, the pair of electrodes 2 are disposed in contact with surfaces of the contained first gel 7, the surfaces intersecting a surface of the contained first gel 7, which surface is in contact with the connecting gel 9.

When a voltage is applied between the electrodes 2 by supplying a current to flow between the pair of electrodes 2 disposed as described above, an electric field is formed between the electrodes 2. By the action of the electric field, a sample is moved in the first gel 7 from the side close to one electrode 2 toward the other electrode 2, whereby the sample is separated. Stated in another way, the sample is separated in the first gel 7 in parallel to the surface of the first gel 7, which surface is in contact with the connecting gel 9.

On the other hand, the electrode 3 is disposed in each of two lateral surfaces intersecting not only the bottom surface of the casing 20, but also the lateral surfaces of the casing 20 in which the electrodes 2 are disposed. Thus, the pair of electrodes 3 are disposed to face each other with the first gel 7, the connecting gel 9, and the second gel 8 interposed between the electrodes 3. One of the pair of electrodes 3 faces a surface of the contained first gel 7, the surface being positioned opposite to the surface of the contained first gel 7, which surface is in contact with the connecting gel 9. The other electrode 3 faces a surface of the contained second gel 8, the surface being positioned opposite to the surface of the contained second gel 8, which surface is in contact with the connecting gel 9.

When a voltage is applied between the electrodes 3 by supplying a current to flow between the pair of electrodes 3 disposed as described above, an electric field is formed between the electrodes 3. By the action of the electric field, the sample is moved from the first gel 7 to the connecting gel 9 and further from the connecting gel 9 to the second gel 8. The sample having reached the second gel 8 is further moved in the second gel 8 from the side close to the connecting gel 9 toward the surface of the second gel 8, which surface is in contact with the third electrode 3, whereby the sample is separated in the moving direction thereof. Stated in another way, the sample is separated in the second gel 8 in the direction intersecting the surface of the second gel 8, which surface is in contact with the connecting gel 9.

Materials of the electrodes 2 and 3 may be, for example, platinum (Pt), gold (Au), or carbon (C). Instead of forming the electrodes 2 and 3, an electrode kit may be prepared separately from the two-dimensional electrophoresis kit 1 such that a voltage is applied to each gel through the electrode kit.

(First Gel 7)

The first gel 7 is a medium to perform first dimensional electrophoresis in the case of performing two-dimensional electrophoresis. As illustrated in FIGS. 1 and 2, the first gel 7 is formed on the first region 4 of the bottom surface of the casing 20 and is attached to the first region 4.

The first gel 7 is formed by gelling a first solution prepared to form the first gel 7. When the isoelectric focusing is performed as the first dimensional electrophoresis, an immobilized pH gradient (IPG) gel, for example, can be used as the first gel 7. In such a case, a solution containing a monomer, e.g., acrylamide or agarose, can be used as the first solution.

The first solution may contain, in addition to the above-mentioned monomer, a reagent such as a cross-linking agent, e.g., N,N′-methylenebisacrylamide, a polymerization initiator, e.g., APS (Ammonium peroxodisulfate), or a polymerization accelerator, e.g., TEMED (N,N,N′,N′-Tetramethylethylenediamine). When a solution containing agarose is used, a carrier ampholite is preferably mixed in the solution.

When the IPG gel is formed as the first gel 7, it is preferable that a pH gradient is given to the first solution in advance, and that the first solution is applied to the first region 4 while the pH gradient is maintained. The pH range of the IPG gel is preferably 3 to 10 and more preferably 4 to 7.

The pH gradient can be given to the first solution forming the IPG gel, for example, by a method of dispersing, into the first solution, an acrylamide derivative (e.g., a commercially available reagent such as Immobilon or acrylamide buffer), which includes a particular substituent (e.g., a carboxyl group or an amino group) and which has a different dissociation constant (pK) value. Stated in another way, the first solution having any desired pH gradient can be obtained by preparing acrylamide derivative solutions that have pH (e.g., pH 3) as a start point of the pH gradient and pH (e.g., pH 10) as an end point of the pH gradient, and by mixing those solutions to each other with a mixing means, e.g., a gradient mixer or a static mixer, while a mixing ratio is changed.

(Second Gel 8)

The second gel 8 is a medium to perform second dimensional electrophoresis in the case of performing two-dimensional electrophoresis. As illustrated in FIGS. 1 and 2, the second gel 8 is formed on the second region 5 of the bottom surface of the casing 20 and is attached to the second region 5.

The second gel 8 is formed by gelling a second solution prepared to form the second gel 8. When the sodium dodecyl sulfate-polyacrylamide gel electrophoresis (SDS-PAGE) is performed as the second dimensional electrophoresis, a separating gel of a sodium dodecyl sulfate-polyacrylamide gel, for example, can be used as the second gel 8. In such a case, a solution containing a monomer, e.g., acrylamide, can be used as the second solution.

When the sodium dodecyl sulfate-polyacrylamide gel is used as the second gel 8, the second solution may contain, in addition to the above-mentioned monomer, a reagent such as a cross-linking agent, e.g., N,N′-methylenebisacrylamide. The second solution may further contain a gel forming buffer, e.g., Tris-HCl, as well as SDS, APS, TEMED, pure water, etc. While a mixing ratio of the monomer and other constituents in the second solution is not limited to a particular value, the second solution may be prepared, for example, such that the concentration of acrylamide is 7.5% by weight to 15% by weight and preferably 10% by weight.

When the separating gel of sodium dodecyl sulfate-polyacrylamide is formed as the second gel 8, the second solution may contain, as a gel forming buffer, a 0.5M Tris-HCl buffer of pH 6.8, for example.

(Connecting Gel 9)

The connecting gel 9 is a medium positioned between the first gel 7 and the second gel 8 and contacting with the first gel 7 and the second gel 8 such that the sample can be moved from the first gel 7 to the connecting gel 9 and moved from the connecting gel 9 to the second gel 8. As illustrated in FIGS. 1 and 2, the connecting gel 9 is formed on the connecting region 6 of the bottom surface of the casing 20 and is attached to the connecting region.

The connecting gel 9 serves to move the sample having been separated in the first gel 7 to the second gel 8. The connecting gel 9 may be a concentrating gel to concentrate the sample such that the separation of the sample in the second gel 8 is appropriately progressed. By concentrating the sample with the connecting gel 9 in such a manner, the sample concentration can be increased so as to further clarify sample spots and bands.

The connecting gel 9 is formed by gelling a connecting solution prepared to form the connecting gel 9. When the SDS-PAGE is performed as the second dimensional electrophoresis, a concentrating gel of a the sodium dodecyl sulfate-polyacrylamide gel can be used as the connecting gel 9. In such a case, a solution containing a monomer, e.g., acrylamide, can be used as the connecting solution. The connecting solution may be mixed with a reagent such as a cross-linking agent, e.g., N,N′-methylenebisacrylamide, a gel forming buffer, e.g., Tris-HCl, as well as SDS, APS, TEMED, pure water, etc.

When the concentrating gel of sodium dodecyl sulfate-polyacrylamide is formed as the connecting gel 9, the connecting solution may contain, as a gel forming buffer, a 1.5M Tris-HCl buffer of pH 8.8, for example.

(Buffer Solution Storage)

In the casing 20, the first buffer solution storage 10 is provided on the side close to the first gel 7, and the second buffer solution storage 11 is disposed on the side close to the second gel 8. More specifically, in the casing 20, the first buffer solution storage 10 is provided in a space between the first gel 7 and one lateral wall of the casing 20, and the second buffer solution storage 11 is provided between the second gel 8 and the opposite lateral wall of the casing 20. A buffer solution supplied to the first gel 7 is filled in the first buffer solution storage 10, and a buffer solution supplied to the second gel 8 and the connecting gel 9 is filled in the second buffer solution storage 11. The buffer solutions are introduced to the first buffer solution storage 10 and the second buffer solution storage 11 such that each buffer solution is supplied to the corresponding gel when the two-dimensional electrophoresis is performed by employing a two-dimensional electrophoresis chip.

The buffer solutions introduced to the first buffer solution storage 10 and the second buffer solution storage 11 are selected as appropriate depending on the types of the first gel 7 and the second gel 8. For example, a glycine-based running buffer containing Tris, glycine, SDS, etc., or a tricine-based running buffer containing Tris, tricine, SDS, etc. can be used. The glycine-based running buffer is preferably used to obtain a high resolution for proteins, and the tricine-based running buffer is preferably used to separate proteins having low molecular weights.

In the casing 20, the first buffer solution storage 10, the first gel 7, the connecting gel 9, the second gel 8, and the second buffer solution storage 11 are arrayed parallel to the bottom surface of the casing 20 in the mentioned order. With such an array, since the sample having been separated in the first gel 7 can be continuously moved to the second gel 8 in the casing 20, the two-dimensional electrophoresis can be readily performed in a shorter time. Furthermore, reduction in size of the casing 20 can be realized.

(Surface Treatment)

As described above, the bottom surface of the casing 20 is subjected to surface treatment. The surface treatment carried out on the bottom surface of the casing 20 is treatment adapted for (i) supplying the first solution prepared to form the first gel 7 and the second solution prepared to form the second gel 8 to respective desired regions of the bottom surface, and (ii) attaching the first gel 7 and the second gel 8 to the desired regions. Thus, the surface treatment can be said as treatment adapted for supplying, to the first region 4, the first solution prepared to form the first gel 7 and attaching the first gel 7 to the first region 4, and for supplying, to the second region 5, the second solution prepared to form the second gel 8 and attaching the second gel 8 to the second region 5.

Similarly, the connecting region 6 is also subjected to surface treatment adapted for supplying, to the connecting region 6, the connecting solution prepared to form the connecting gel 9, and attaching the connecting gel 9 to the connecting region 6. The surface treatment for the bottom surface of the casing 20 may be carried out in the respective regions before the first gel 7, the second gel 8, and the connecting gel 9 are formed.

With the surface treatment carried out on the bottom surface of the casing 20 as described above, when the first solution, the second solution, and the connecting solution are applied to the bottom surface of the casing 20, the applied solutions are spread over the respective desired regions, whereby the first gel 7, the second gel 8, and the connecting gel 9 can be formed in the respective desired regions. Moreover, the formed gels can be attached to the desired regions, respectively. In other words, it is possible to improve both wettability of the bottom surface of the casing 20 with respect to the first solution, the second solution, and the connecting solution, and adhesion of the formed first gel 7, second gel 8, and connecting gel 9 with respect to the bottom surface of the casing 20.

Accordingly, the first gel 7, the second gel 8, and the connecting gel 9 can be immobilized to the bottom surface of the casing 20 in desired patterns. As a result, the connection between the first gel 7 and the connecting gel 9 and the connection between the connecting gel 9 and the second gel 8 in the bottom surface of the casing 20 are strengthened. Hence the number of spots of the sample moving from the first gel 7 to the second gel 8 through the connecting gel 9 is increased, and the intensity in detection of the spots is enhanced. In addition, since the number of spots of the sample moving from the first gel 7 to the second gel 8 through the connecting gel 9 is increased, a loss of the sample is reduced.

The type of the surface treatment carried out on the bottom surface is not limited to particular one insofar as wettability of the bottom surface is increased and a surface state of the bottom surface is modified such that the formed gel can be immobilized to the desired region. The surface treatment may be carried out, for example, as nitration treatment, sulfonation treatment, hydrophilic polymer coating treatment, graft polymer coating treatment, microdot forming treatment, nanodot forming treatment, nanoimprint treatment, or oxygen plasma treatment. By carrying out any of those surface treatments, a surface treatment film having high hydrophillicity and high adhesion to the corresponding gel can be formed on the bottom surface of the casing 20. In the case of surface-treating the desired region of the bottom surface of the casing 20, the surface treatment may be carried out on the bottom surface of the casing 20 after masking other regions than the desired region.

When the microdot forming treatment, the nanodot forming treatment, or the nanoimprint treatment is carried out as the surface treatment on the bottom surface of the casing 20, concave and convex shapes in sizes of nanometer to micrometer can be formed in the bottom surface.

When the hydrophilic polymer coating treatment, the graft polymer coating treatment, or the oxygen plasma treatment is carried out as the surface treatment on the bottom surface of the casing 20, a thin film improved in wettability and adhesion is formed on the bottom surface. Among those surface treatments for forming such a thin film, in particular, the oxygen plasma treatment is preferably carried out on the bottom surface of the casing 20. After carrying out the oxygen plasma treatment, the surface treatment may be further continued by introducing, e.g., a gasified acrylic acid into a stream of plasma.

With the above-mentioned treatment, a functional group containing oxygen can be applied to the bottom surface of the casing 20. Accordingly, even when the bottom surface of the casing 20 is made of a hydrophobic material, the bottom surface can be easily made hydrophilic. The functional group containing oxygen is preferably applied in an amount as large as possible to the bottom surface having been subjected to the oxygen plasma treatment. This contributes to further improving the wettability of the bottom surface.

The bottom surface of the casing 20 made of an organic resin may be treated to become hydrophilic by carrying out the above-mentioned oxygen plasma treatment on the bottom surface. Alternately, the hydrophilic bottom surface of the casing 20 may be obtained by forming the casing 20 with the use of an organic resin that has the functional group containing oxygen.

[Method for Manufacturing Two-Dimensional Electrophoresis Kit 1]

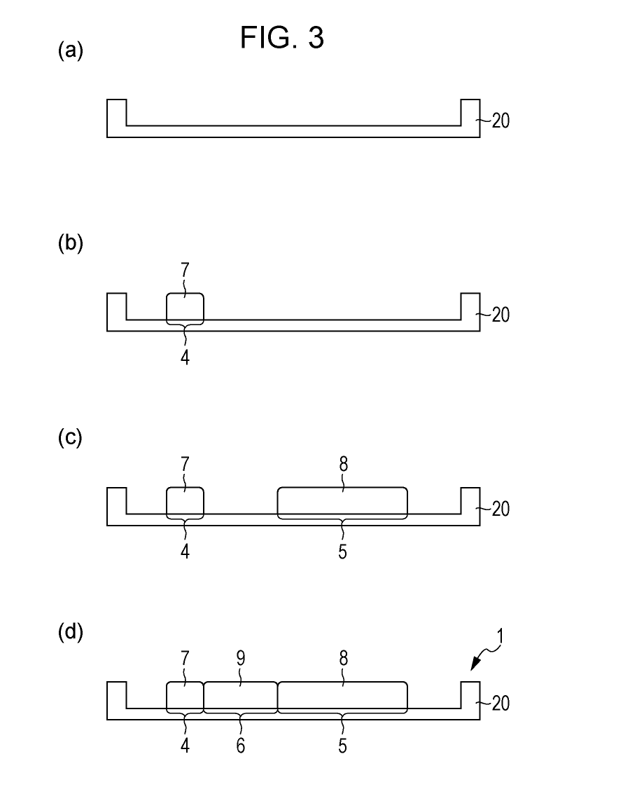

A method for manufacturing the two-dimensional electrophoresis kit 1 will be described below with reference to FIG. 3. FIG. 3 is a schematic view to explain the method for manufacturing the two-dimensional electrophoresis kit according to the one embodiment of the present invention.

(Formation of First Gel 7)

First, the casing 20 is prepared as illustrated in FIG. 3(a), and surface treatment is carried out on the first region 4 of the bottom surface of the casing 20 as illustrated in FIG. 3(b) (first surface treatment step). For example, the oxygen plasma treatment may be carried out as the surface treatment on the first region 4.

Then, the first solution prepared to form the first gel 7 is applied to the first region 4 after the surface treatment, thereby forming the first gel 7 (first forming step). The application of the first solution to the first region 4 can be performed by discharging the first solution containing a monomer of acrylamide, for example, to the first region 4 with an ink jet means, or by spraying the first solution in a gas state to the first region 4. More specifically, a gel-forming mixed solution prepared using a mixer, e.g., a static mixer, may be discharged to the first region 4 by employing a discharge means (not illustrated), e.g., a liquid sprayer, a constant-quantity discharging device (dispenser), or a sampler. By applying the first solution to the first region 4 with, e.g., the ink jet means as described above, the first solution can be properly applied to the first region 4.

When the first solution is discharged from the above-mentioned discharge means, the polymerization initiator and the polymerization accelerator may be separately added to the first solution discharged from the discharge means instead of adding the polymerization initiator and the polymerization accelerator to the first solution, which is supplied to the discharge means, such that gelling of the first solution will not progress inside the discharge means.

Because the first region 4 has been subjected to the surface treatment, wettability of the first region 4 with respect to the first solution is improved. Hence the first solution is properly spread over the first region 4. The first gel 7 is then formed in the first region 4 by polymerizing the monomer contained in the first solution, which has been applied to the first region 4, to thereby gel the first solution. With the first region 4 being subjected to the surface treatment, adhesion between the formed first gel 7 and the first region 4 is improved. Accordingly, the first gel 7 can be immobilized to the first region 4.

The immobilized pH gradient (IPG) gel can be formed as the first gel 7 by employing, as the first solution, a solution containing a monomer, e.g., acrylamide or agarose. While gelling conditions for the first solution are not limited to particular ones, the gelling may be performed, for example, in a nitrogen atmosphere under control of temperature in the range of 20 to 50° C.

The solution containing the sample may be introduced to the first gel 7 when the two-dimensional electrophoresis is performed using the manufactured two-dimensional electrophoresis chip. Alternatively, a mixed solution may be prepared by mixing a solution containing the sample to the first solution, and the mixed solution may be applied to and gelled in the first region 4 when the first gel 7 is formed.

By forming the first gel 7 with the use of the first solution containing the sample as described above, a long time is not required to introduce the sample into a dried gel, whereby a time required for introducing the sample into the first gel 7 can be shortened. Furthermore, there is no loss of the sample, which may be generated when the sample is introduced into the dried gel.

Instead of applying the first solution to the first region 4 and gelling the first solution when the first gel 7 is formed, the first gel 7 may be formed by attaching the first solution, which has been gelled in advance, to the first region 4.

(Formation of Second Gel 8)

Next, as illustrated in FIG. 3(c), surface treatment is carried out on the second region 5 of the bottom surface of the casing 20 (second surface treatment step). The surface treatment carried out on the second region 5 may be the same as or different from the above-described surface treatment carried out on the first region 4.

The second solution prepared to form the second gel 8 is then applied to the second region 5 after the surface treatment, thereby forming the second gel 8 (second forming step). The application of the second solution to the second region 5 can be performed in a similar manner to the above-described application of the first solution to the first region 4.

Because the second region 5 has been subjected to the surface treatment, wettability of the second region 5 with respect to the second solution is improved. Hence the second solution is properly spread over the second region 5. The second gel 8 is then formed in the second region 5 by polymerizing a monomer contained in the second solution, which has been applied to the second region 5, to thereby gel the second solution. With the second region 5 being subjected to the surface treatment, adhesion between the formed second gel 8 and the second region 5 is improved. Accordingly, the second gel 8 can be immobilized to the second region 5.

The sodium dodecyl sulfate-polyacrylamide gel can be formed as the second gel 8 by employing, as the second solution, a solution containing, e.g., a sodium dodecyl sulfate-polyacrylamide monomer and having an acrylamide concentration of 10% by weight. When a separating gel of sodium dodecyl sulfate-polyacrylamide is formed as the second gel 8, a 0.5M Tris-HCl buffer of pH 6.8, for example, can be used as a gel forming buffer that is contained in the connecting solution.

Instead of applying the second solution to the second region 5 and gelling the second solution when the second gel 8 is formed, the second gel 8 may be formed by attaching the second solution, which has been gelled in advance, to the second region 5.

(Formation of Connecting Gel 9)

Next, as illustrated in FIG. 3(d), surface treatment is carried out on the connecting region 6 of the bottom surface of the casing 20 (connecting-region surface treatment step). The surface treatment carried out on the connecting region 6 may be the same as or different from the above-described surface treatment carried out on the first region 4.

The connecting solution prepared to form the connecting gel 9 is then applied to the connecting region 6 after the surface treatment, thereby forming the connecting gel 9 (connecting-medium forming step). The application of the connecting solution to the connecting region 6 can be performed in a similar manner to the above-described application of the first solution to the first region 4.

Because the connecting region 6 has been subjected to the surface treatment, wettability of the connecting region 6 with respect to the connecting solution is improved. Hence the connecting solution is properly spread over the connecting region 6. The connecting gel 9 is then formed in the connecting region 6 by polymerizing a monomer contained in the connecting solution, which has been applied to the connecting region 6, to thereby gel the connecting solution. With the connecting region 6 being subjected to the surface treatment, adhesion between the formed connecting gel 9 and the connecting region 6 is improved. Accordingly, the connecting gel 9 can be immobilized to the connecting region 6.

The connecting gel 9 is formed to be contacted with both the first gel 7 and the second gel 8, and to allow movement of the sample from the first gel 7 to the connecting gel 9 and movement of the sample from the connecting gel 9 to the second gel 8. Thus, the connecting region 6 is positioned between the first region 4 and the second region 5 in a state contacted with both the first region 4 and the second region 5.

When the second gel 8 is the separating gel of the sodium dodecyl sulfate-polyacrylamide gel, the concentrating gel thereof may be formed as the connecting gel 9. The concentrating gel of sodium dodecyl sulfate-polyacrylamide can be formed, for example, by employing, as the connecting solution, a mixture resulting from mixing, e.g., a 1.5M Tris-HCl buffer of pH 8.8, as a gel forming buffer, to a solution containing a sodium dodecyl sulfate-polyacrylamide monomer and having an acrylamide concentration of 4 to 5% by weight.

Instead of applying the connecting solution to the connecting region 6 and gelling the connecting solution when the connecting gel 9 is formed, the connecting gel 9 may be formed by attaching the connecting solution, which has been gelled in advance, to the connecting region 6.

By manufacturing the two-dimensional electrophoresis kit 1 as described above, the first gel 7, the second gel 8, and the connecting gel 9 are formed on the surface-treated bottom surface of the casing 20. As a result, wettability of the bottom surface of the casing 20 to the solution forming each of the gels is improved, and adhesion between each of the formed gels and the bottom surface is also improved.

Accordingly, the first gel 7, the second gel 8, and the connecting gel 9 can be formed in respective desired patterns on the desired regions of the bottom surface of the casing 20 with high accuracy. Furthermore, since the first gel 7, the second gel 8, and the connecting gel 9 can be immobilized, the connection between the first gel 7 and the second gel 8 through the connecting gel 9 is strengthened.

It is to be noted that the above-described step of carrying out the surface treatment on the first region 4 and forming the first gel 7 may be exchanged in order with the step of carrying out the surface treatment on the second region 5 and forming the second gel 8, and that the step of carrying out the surface treatment on the connecting region 6 and forming the connecting gel 9 may be performed prior to the other steps. Furthermore, after carrying out the surface treatments on all the first region 4, the second region 5 and the connecting region 6 of the bottom surface of the casing 20 (surface treatment step), the first gel 7, the second gel 8, and the connecting gel 9 may be formed (forming step) by applying the first solution, the second solution, and the connecting solution to the corresponding regions, respectively. Thus, the order in carrying out the surface treatments and the order in forming the gels are not limited to particular ones. In other words, it is just required that, before each gel is formed, a predetermined region where the relevant gel is formed has been subjected to the surface treatment. Alternatively, all the regions may be subjected to the surface treatment at the same time.

[Two-Dimensional Electrophoresis Method]

The two-dimensional electrophoresis of a sample using the two-dimensional electrophoresis kit 1 described above can be practiced by an electrophoresis method known in the related art.

(Sample)

A preparation sampled from biological materials, such as an individual organism, a biological fluid, a cell strain, a tissue culture, and a tissue fragment, can be properly used as the sample that is introduced to the two-dimensional electrophoresis kit 1 and is separated through the two-dimensional electrophoresis. In particular, polypeptide or polynucleotide is preferably used. A sample labeled with a fluorescent substance may also be used. Those samples may be each used in the two-dimensional electrophoresis after being prepared as a solution, which is mixed with a buffer containing Tris-HCl, SDS, mercaptoethanol, glycerol, etc. and which is stained with bromophenol blue, for example.

(First Dimensional Electrophoresis)

First, buffer solutions for the electrophoresis are supplied to the first buffer solution storage 10 and the second buffer solution storage 11. Then, a solution containing a sample is introduced to the first gel 7. Thereafter, first dimensional separation of the sample is performed in the first gel 7 by applying a voltage between the electrodes 2. For example, when the first gel 7 is a pH immobilized gel, the sample can be separated by utilizing the difference in isoelectric point (pI; Isoelectric point) among sample components. Separation conditions for the isoelectric focusing may be set to those known in the related art. The sample may be separated, for example, by applying a constant voltage of 6 kV between the electrodes 2.

(Second Dimensional Electrophoresis)

Next, by applying a voltage between the electrodes 3, the sample having been separated in the first gel 7 is moved to the connecting gel 9 while a pattern resulting from the first dimensional separation is maintained. The sample is further moved in the connecting gel 9, whereby the sample is concentrated. The concentrated sample is moved from the connecting gel 9 to the second gel 8, and second dimensional separation of the sample is performed in the second gel 8. For example, when the second gel 8 is the separating gel of the sodium dodecyl sulfate-polyacrylamide gel and the connecting gel 9 is the concentrating gel thereof, the sample components having molecular weights distributed over a wide range can be separated with high accuracy by utilizing both the concentration of the sample developed with the concentrating gel and the molecular sieve effect developed with the separating gel. Separation conditions for the SDS-PAGE may be set to those known in the related art. The sample may be separated, for example, by supplying a low current of 20 mA to flow between the electrodes 3.

With the two-dimensional electrophoresis method according to one embodiment of the present invention, the number of spots moving from the first gel 7 to the second gel 8 through the connecting gel 9 can be increased and the intensity in detection of the sample can be enhanced by separating the sample through the two-dimensional electrophoresis using the two-dimensional electrophoresis kit 1. Furthermore, since the number of spots moving from the first gel 7 to the second gel 8 can be increased, a loss of the sample can be reduced.

In another example of the two-dimensional electrophoresis method according to the one embodiment of the present invention, the separation of the sample through the two-dimensional electrophoresis may be performed at the same time as the manufacturing of the two-dimensional electrophoresis kit 1. In other words, first dimensional separation of a sample (first electrophoresis step) may be performed in the first gel 7 after carrying out the surface treatment on the first region 4 of the bottom surface of the casing 20 and forming the first gel 7 in the first region 4, and after the first dimensional separation of the sample, second dimensional separation of the sample (second electrophoresis step) may be performed by carrying out the surface treatment on each of the second region 5 and the connecting region 6 to form the second gel 8 and the connecting gel 9, respectively, and by moving the sample having been separated in the first gel 7 to the second gel 8 through the connecting gel 9.

[Two-Dimensional Electrophoresis Chip]

A two-dimensional electrophoresis chip according to one embodiment of the present invention includes the casing 20 that contains gels. A bottom surface of the casing 20 is contacted with the first gel 7 for the first dimensional electrophoresis and with the second gel 8 for the second dimensional electrophoresis, the second gel 8 being directly or indirectly contacted with the first gel 7 such that the sample can be moved from the first gel 7 to the second gel 8. Furthermore, the bottom surface of the casing 20 is surface-treated such that the first gel 7 and the second gel 8 are attached to desired regions by supplying, to the respective desired regions, the first solution to form the first gel 7 and the second solution to form the second gel 8.

Thus, the scope of the present invention further involves the casing 20 of the above-described two-dimensional electrophoresis kit 1 in a state where the bottom surface thereof is surface-treated as described above and where the first gel 7, the second gel 8, and the connecting gel 9 are not contained.

### Second Embodiment

[Two-Dimensional Electrophoresis Kit and Method for Manufacturing Same]

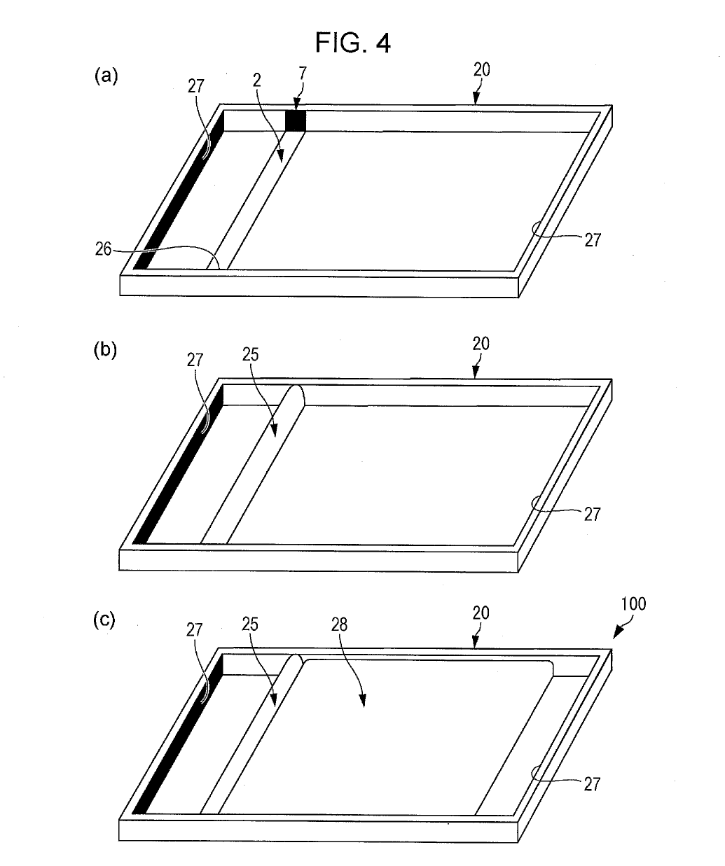

Another example of each of the two-dimensional electrophoresis kit and the method for manufacturing the two-dimensional electrophoresis kit will be described below with reference to FIG. 4. FIG. 4 is a schematic view to explain a method for manufacturing a two-dimensional electrophoresis kit 100 according to another embodiment of the present invention.

The two-dimensional electrophoresis kit 100 of a second embodiment is different from the two-dimensional electrophoresis kit 1 of the first embodiment in that the first gel 7 and the second gel 13 are directly contacted with each other without disposing the connecting gel 9. Regarding the second embodiment, different points from the first embodiment are described in detail, and the other details are omitted. Similar members in the second embodiment to those in the first embodiment are denoted by the same reference signs, and detailed description of those members is omitted.

First, the casing 20 is prepared as illustrated in FIG. 4(a), and surface treatment is carried out on the first region 4 of the bottom surface of the casing 20 as illustrated in FIG. 4(b). Then, the first solution prepared to form the first gel 7 is applied to the first region 4 after the surface treatment, thereby forming the first gel 7. For example, an IPG gel is formed as the first gel 7 by employing, as the first solution, a solution containing a monomer of, e.g., acrylamide.

Next, as illustrated in FIG. 4(c), surface treatment is carried out on a second region 12 of the bottom surface of the casing 20. A second solution prepared to form a second gel 13 is applied to the second region 12 after the surface treatment, thereby forming the second gel 13. The first gel 7 and the second gel 13 are formed in direct contact with each other such that the sample can be moved from the first gel 7 to the second gel.

In the two-dimensional electrophoresis kit 100, preferably, an IPG gel is formed as the first gel 7, and a gradient gel given with a concentration gradient of monomer is formed as the second gel 13. For example, by forming a gradient gel of polyacrylamide given with a concentration gradient of acrylamide, sample components having molecular weights distributed over a wide range can be separated with high accuracy without disposing a concentrating gel between the first gel 7 and the second gel 13.

Such a gradient gel can be formed, for example, by employing an acrylamide solution with a high concentration (10% to 20%), and an acrylamide solution with a low concentration (5% to 10%). More specifically, an acrylamide mixed solution (gradient gel solution) having any desired concentration gradient can be prepared by mixing those two acrylamide solutions to each other with a mixing means, e.g., a gradient mixer or a static mixer, while a mixing ratio is changed. Then, the acrylamide mixed solution is applied to the second region 12 by employing a discharge means, e.g., an ink jet means, a liquid sprayer, a constant-quantity discharging device (dispenser), or a sampler, and is gelled. As a result, the gradient gel can be formed as the second gel 13 in the second region 12.

Thus, by surface-treating the bottom surface of the casing 20 and applying the first solution and the second solution to the bottom surface of the casing 20, those solutions can be spread over the desired regions, and the first gel 7 and the second gel 13 can be formed in the respective desired regions. Furthermore, the formed gels can be attached to the desired regions. In other words, it is possible to improve both wettability of the bottom surface of the casing 20 with respect to the first solution and the second solution, and adhesion of the formed first gel 7 and second gel 13 with respect to the bottom surface of the casing 20.

Accordingly, the first gel 7 and the second gel 13 can be immobilized to the bottom surface of the casing 20 in the desired patterns. As a result, the connection between the first gel 7 and the second gel 8 in the bottom surface of the casing 20 is strengthened. Hence the number of spots of the sample moving from the first gel 7 to the second gel 13 is increased, and the intensity in detection of the spots is enhanced. In addition, since the number of spots of the sample moving from the first gel 7 to the second gel 13 is increased, a loss of the sample is reduced.

Moreover, in the two-dimensional electrophoresis kit 100, the first buffer solution storage 10, the first gel 7, the second gel 13, and the second buffer solution storage 11 are arrayed along a flow of process in the two-dimensional electrophoresis, the process including the first dimensional separation, the movement, and the second dimensional separation of the sample. Therefore, the two-dimensional electrophoresis can be performed in a shorter time. Since the sample having been separated in the first gel 7 can be continuously moved to the second gel 13 inside the casing 20, the two-dimensional electrophoresis can be performed more readily. In addition, since individual constituent elements are arrayed within the casing 20 parallel to the bottom surface thereof, size reduction of the casing 20 can be realized.

The scope of the present invention further involves not only a two-dimensional electrophoresis method of practicing the two-dimensional electrophoresis of a sample by employing the two-dimensional electrophoresis kit 100 manufactured as described above, but also a two-dimensional electrophoresis chip including the casing 20 of the two-dimensional electrophoresis kit 100 in a state where the bottom surface thereof is surface-treated as described above and where the first gel 7 and the second gel 13 are not contained.

The present invention is not limited to the above-described embodiments, and it can be variously modified within the scope defined in Claims. Other embodiments obtained by appropriately combining the technical means, disclosed in the different embodiments, with each other are also involved in the technical scope of the present invention.

### Third Embodiment

[1. Method of Preparing Isoelectric Focusing Gel]

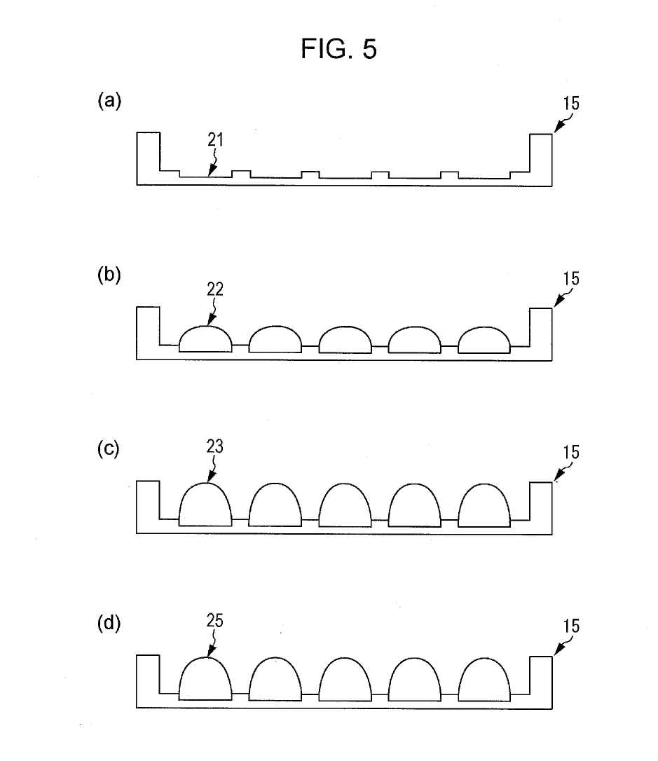

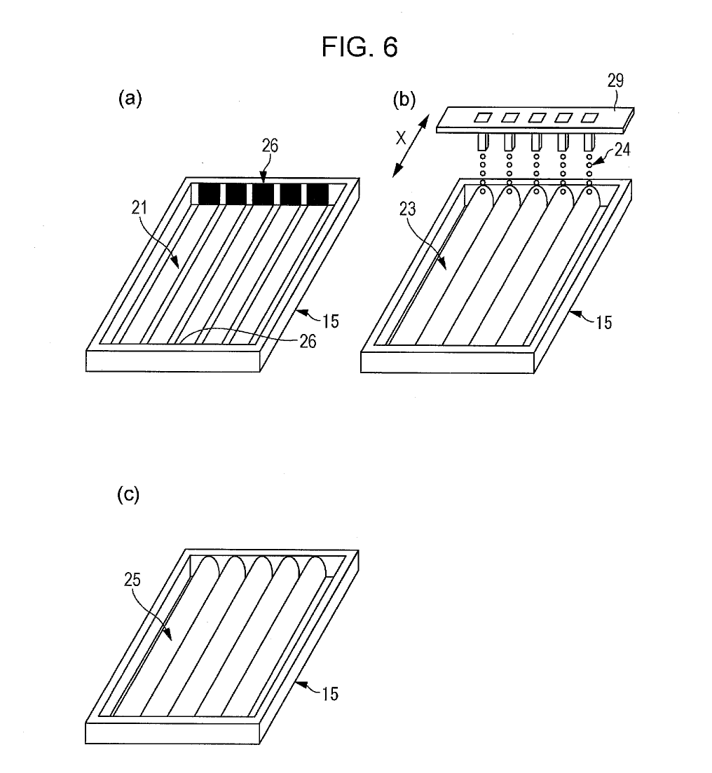

A method of preparing an isoelectric focusing gel according to one embodiment of the present invention will be described below with reference to the drawings. FIGS. 5 and 6 illustrate a gelling step to prepare an isoelectric focusing gel according to one embodiment of the present invention. The method of preparing the isoelectric focusing gel according to this embodiment is able to prepare the isoelectric focusing gel through a gelling step to gel a sample-containing solution as follows. The gelling step is described below in order of two divided steps, i.e., a storing sub-step and an adding sub-step.

(Storing Sub-Step)

As illustrated in FIGS. 5(a) and 6(a), a casing 15 (isoelectric focusing instrument) is used in this embodiment. The casing 15 includes a groove (storage region) 21 to store a sample containing solution 22, and an electrode 2 to apply a voltage. In the method of preparing the isoelectric focusing gel according to this embodiment, the sample containing solution 22 is first stored in the groove 21 of the casing 15.

The casing 15 is an instrument that is used to separate biological macromolecules, such as DNA (Deoxyribonucleic acid) and RNA (Ribonucleic acid), by employing a gel for isoelectric focusing (i.e., an isoelectric focusing gel 25).

The casing 15 is not limited to particular one insofar as the casing 15 is able to contain electrophoresis gels commonly used by those skilled in the art. The shape of the casing 15 is not limited to such a flat plate as illustrated in FIGS. 5 and 6, and the casing 15 may be, e.g., a chip molded into a desired shape. While FIGS. 5 and 6 illustrate the casing 15 capable of processing five samples at the same time, this embodiment is not limited to that type of casing. The casing 15 is just required to be able to process one or more samples. Furthermore, the casing 15 may be formed in a state integral with a second dimensional electrophoresis instrument.

The casing 15 may be made of one selected from among, e.g., plastic materials such as a polymethyl methacrylate (PMMA) resin, polyethylene terephthalate (PET), and polycarbonate (PC), glass materials such as soda-lime glass and borosilicate glass, and ceramic materials such as aluminum oxide (Al₂O₃), zirconia oxide (ZrO₂), aluminum nitride (AlN), and silicon carbide (SiC).

As illustrated in FIGS. 5(a) and 6(a), the groove 21 is formed five in a part of the surface of the casing 15, and it has a recessed structure. The sample containing solution 22, described later, is introduced to the groove 21 that defines a region where the sample containing solution 22 can be stored. Finally, the isoelectric focusing gel 25, described later, is formed in the groove 21.

A method of forming the groove 21 may be selected depending on the material of the casing 15. For example, when the casing 15 is made of the glass material, the recessed structure can be formed by photolithography, i.e., a process of masking other regions than the desired region with a photoresist mask, and etching the desired region for patterning. When the casing 15 is made of the resin material, the recessed structure can be formed by cutting or injection molding.

It is to be noted that the shape of the groove 21 is not limited to the illustrated one insofar as the shape of the groove 21 allows the isoelectric focusing to be performed. The number of the grooves 21 formed in the casing 15 is also not limited to a particular value.

The sample containing solution 22 is a solution containing a sample to be separated through the isoelectric focusing. Examples of the sample may be nucleic acids such as DNA and RNA, and proteins. While the sample containing solution 22 is stored in the groove 21, a method of introducing the solution to the groove 21 is not limited to particular one. For example, the sample containing solution 22 containing biological macromolecules, such as DNA, RNA, and proteins, is applied to the groove 21. A method of applying the sample containing solution 22 can be practiced, for example, by employing a liquid constant-quantity discharging device (dispenser), or by manual operation using a pipetter or the like.

By applying the sample containing solution 22 to flow into the groove 21 of the casing 15 as described above, the sample containing solution 22 is stored in the groove 21 as illustrated in FIG. 5(b). Preferably, the sample containing solution 22 is applied to flow into the groove 21 such that the solution is uniformly stored in the groove 21.

(Adding Sub-Step)

Then, as illustrated in FIGS. 5(c) and 6(b), a gel monomer containing a gel forming material is added to the sample containing solution 22 held in the groove 21. As a result, the sample containing solution 22 and the gel monomer are mixed with each other, thus providing a mixed solution (isoelectric focusing gel solution) 23. By gelling the mixed solution 23, the isoelectric focusing gel 25 can be formed.

The gel forming material is a material forming a gel that serves as a support in the process of isoelectric focusing. For example, a material known in the related art, such as acrylamide, an acrylamide derivative, and agarose, can be used as the gel forming material.

Among those examples, agarose is able to form a gel depending on a temperature condition. In the case of employing acrylamide or an acrylamide derivative, however, it is required to further add a reagent to form a gel. Examples of such a reagent include a cross-linking agent, e.g., N,N′-methylenebisacrylamide, a polymerization initiator, e.g., APS (Ammonium peroxodisulfate), and a polymerization accelerator, e.g., TEMED (N,N,N′,N′-Tetramethylethylenediamine). The reagent may be contained in a mixing solution 23, may be added to the sample containing solution 22 before adding the gel monomer, or may be added to the mixed solution 23 after adding the gel monomer.

Furthermore, the gel monomer is preferably added in a state having a pH gradient to the sample containing solution 22. By adding the gel monomer having the pH gradient to the sample containing solution 22, the mixed solution 23 having a pH gradient is formed. Thus, the finally formed isoelectric focusing gel 25 can be given with the pH gradient. As a result, an Immobilized pH Gradient (IPG) gel can be formed readily, and the isoelectric focusing can be performed satisfactorily. However, this embodiment is not limited to the above-described method. For example, another reagent (e.g., a carrier ampholite) for giving a pH gradient may be separately added without giving a pH gradient to the mixing solution 23.

The pH gradient can be given to the mixing solution 23, for example, by a method of dispersing, into the mixing solution 23, an acrylamide derivative (e.g., Immobilon), which includes a particular substituent (e.g., a carboxyl group or an amino group) and which has a different dissociation constant (pK) value. Stated in another way, the mixing solution 23 having any desired pH gradient can be obtained by preparing acrylamide derivative solutions that have pH (e.g., pH 3) as a start point of the pH gradient and pH (e.g., pH 10) as an end point of the pH gradient, and by mixing those solutions to each other with a mixing means, e.g., a gradient mixer or a static mixer, while a mixing ratio is changed.

The mixing solution 23 may further contain a reagent (e.g., a buffer solution) for the isoelectric focusing. The reagent for the isoelectric focusing may be added to the sample containing solution 22 before adding the gel monomer, or may be added to the mixed solution 23 after adding the gel monomer.

The gel monomer may be added, for example, by a method of employing a discharge means, e.g., an ink jet means, a liquid sprayer, a constant-quantity discharging device (dispenser), or a sampler. When the ink jet means is used, the mixing solution 23 may be discharged, as illustrated in FIG. 6(b), while an ink jet head 29 is scanned in the X-direction denoted in the drawing.

When the gel monomer is supplied to the above-mentioned discharge means in advance, the polymerization initiator, the polymerization accelerator, etc. are preferably added separately from the gel forming material such that gelling will not progress inside a device of the discharge means.

Temperature may be controlled to be held at 20 to 50° C. in a nitrogen atmosphere in order to progress the gelling after the gel monomer or the reagents, such as the polymerization initiator and the polymerization accelerator, have been added.

The isoelectric focusing gel 25 according to this embodiment can be prepared as described above. Since the isoelectric focusing gel 25 according to this embodiment contains the sample, a long time is not required to introduce the sample into a dried gel, whereby a time required for introducing the sample into the isoelectric focusing gel 25 can be shortened. Furthermore, there is no loss of the sample, which may be generated due to insufficient swelling of the dried gel when the sample is introduced, and the sample can be immobilized in its all amount to the isoelectric focusing gel 25.

Thus, according to this embodiment, the isoelectric focusing gel can be prepared with improved efficiency in introducing the sample.

(Surface Treatment)

The surface of the groove 21 may be subjected to surface treatment in advance. The surface treatment may be carried out, for example, as treatment for making the surface of the groove 21 hydrophilic.

A hydrophilic region can be formed on the surface of the groove 21 by hydrophilic treatment, such as nitration treatment using sulfuric acid, sulfonation treatment using nitric acid, hydrophilic polymer coating treatment, graft polymer treatment, micro (nano)-dot forming treatment, or oxygen plasma treatment.

In particular, the oxygen plasma treatment is preferably used as the hydrophilic treatment. The oxygen plasma treatment enables an oxygen-containing functional group to be introduced to the surface of the groove 21. Therefore, when the surface of the groove 21 is made of a hydrophobic material, a hydrophilic region can be formed readily.

Furthermore, the hydrophilic region preferably has a composition containing the oxygen-containing functional group in larger amount. To that end, an organic resin having the oxygen-containing functional group may be used as the casing 20, or a commercially available organic resin may be used as the casing 20 after treating the organic resin to become hydrophilic. When the hydrophilic region has the composition containing the oxygen-containing functional group in larger amount, higher wettability is obtained.

By carrying out the surface treatment as described above, it is possible to improve not only wettability of the sample containing solution 22 and the mixed solution 23 with respect to the groove 21, but also adhesion of the isoelectric focusing gel 25 with respect to the groove 21.

The surface of the groove 21 may be treated in a plasma atmosphere by introducing acrylamide or an acrylamide derivative and inert gas. With that surface treatment, the acrylamide used in the surface treatment is coupled or cross-linked to acrylamide etc. contained in the mixed solution, whereby the adhesion of the isoelectric focusing gel 25, which is a polyacrylamide gel, with respect to the groove 21 can be improved.

Hydrophobizing treatment may be carried out on, e.g., the surroundings of the groove 21. When the casing 15 is made of a glass substrate, for example, a portion becoming a hydrophilic region (i.e., the surface of the groove 2) is masked with, e.g., a Kapton tape, and other regions than the relevant portion is made hydrophobic by treating the other regions with a silane coupling agent. Furthermore, the hydrophilic region can be obtained by irradiating the portion, which is to become the hydrophilic region, with an ultraviolet ray after hydrophobizing the casing 15 with a photodegradable silane coupling agent. As a result, the hydrophilic region and the hydrophobic region can be formed on the casing 15.

When the casing 15 is made of a silicon substrate, for example, a portion becoming a hydrophilic region may be masked with a natural oxide film, and other regions than the relevant portion may be made hydrophobic by wet-etching the other regions with a dilute hydrofluoric acid. As an alternative, after cleaning an entire region with dilute hydrofluoric acid in advance, oxidation treatment may be carried out in a state masking other regions than the relevant portion. Such a method can also form the hydrophilic region and the hydrophobic region on the casing 15.

Thus, the surface of the groove 21 can be provided as the hydrophilic region and the surface of the casing 15 other than the surface of the groove 21 can be provided as the hydrophobic region with the chemical surface treatment. As a result, the region where the sample containing solution 22 and the mixed solution 23 are stored can be restricted properly.

It is to be noted that the above-mentioned surface treatment needs to be carried out on at least a part of the groove 21 and is not required to be carried out over the entire surface of the groove 21.

(Modifications)

The storage region where the sample containing solution 22 and the mixed solution 23 are stored in the storing sub-step is not necessarily required to be in the form of a groove, and it may be a region not allowing the sample containing solution 22 to flow out. For example, surface treatment may be carried out on the casing 15 instead of the groove 21 to form a hydrophilic region surrounded by a hydrophobic region such that the sample containing solution 22 and the mixed solution 23 are stored in the hydrophilic region. By thus making hydrophilic the region where the sample containing solution 22 and the mixed solution 23 are stored, it is possible to improve not only wettability of the sample containing solution 22 and the mixed solution 23 with respect to the storage region, but also adhesion of the isoelectric focusing gel 25 with respect to the storage region.

As another example of the storage region, the storage region may have a protruded structure on which the sample containing solution 22 is placed and held by the action of surface tension. As still another example of the storage region, the storage region may have a plurality of concave-convex structures such that the sample containing solution 22 is stored on a surface having wettability improved with the plural concave-convex structures. Those plural concave-convex structures may have depths or thicknesses of several nanometers to several tens nanometers, for example, and they may be formed by employing the generally known nanoprint technique. The sample containing solution 22 may be stored in a region including the above-mentioned structures in a combined state.

While, in this embodiment, the sample containing solution 22 is first stored in the groove and the gel monomer is then added to the sample containing solution 22, the sequence may be reversed. Stated in another way, after applying, to the groove 21, the gel monomer that contains the gel forming material such as acrylamide, the sample containing solution 22 may be added to the gel monomer to be gelled. In such a case, however, it is preferable to avoid a concentration gradient formed by the acrylamide derivative, for example, from being disturbed with addition of the sample containing solution 22 to the gel monomer.

[2. Isoelectric Focusing Step]

The following is description about a method of performing the isoelectric focusing of the sample in the isoelectric focusing gel, which has been prepared by the method of preparing the isoelectric focusing gel, the method including the above-described gelling step.

Next, as illustrated in FIGS. 5(d) and 6(c), the isoelectric focusing is performed by employing the casing 15 including the IPG gel (i.e., the isoelectric focusing gel 25), which has been formed in the groove 21 in the above-described gelling step and which contains the sample.

The casing (isoelectric focusing instrument) 15 includes a pair of electrodes (voltage applying means) 2 disposed at opposite ends of the groove 21, respectively, in the lengthwise direction of the isoelectric focusing gel 25. Therefore, by applying a voltage between the electrodes 2 after introducing a buffer solution for electrophoresis to the casing 15, the sample can be separated in accordance with the pH gradient in the isoelectric focusing gel 25 and with the difference in isoelectric point among sample components. For example, platinum electrodes can be used as the pair of electrodes 2.

Since the isoelectric focusing of the sample is performed using the isoelectric focusing gel 25 containing the sample, the isoelectric focusing can be started as soon as the preparation of the isoelectric focusing gel 25 is completed. Accordingly, a time from the start of the preparation of the isoelectric focusing gel 25 to the end of the isoelectric focusing can be shortened.

Furthermore, by applying the voltage to the isoelectric focusing gel 25 according to this embodiment, sample separation can be performed in accordance with respective isoelectric points of individual sample components.

The isoelectric focusing method using the isoelectric focusing gel 25 according to this embodiment can also be performed without employing the casing 15. Thus, it is just required to be able to apply the voltage to the isoelectric focusing gel 25 through any suitable means.

(Two-Dimensional Electrophoresis Instrument)

Biological macromolecules can be separated with a higher resolution by performing two-dimensional electrophoresis while the isoelectric focusing according to this embodiment is performed as first dimensional electrophoresis.

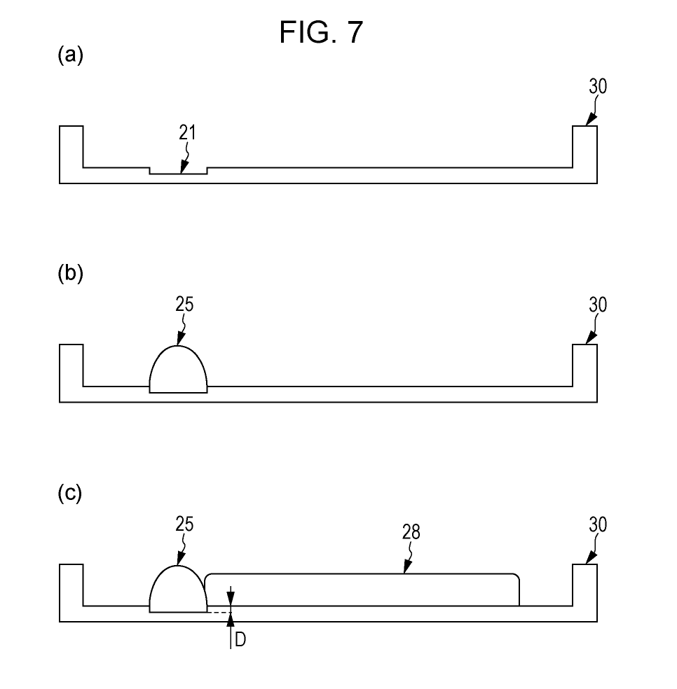

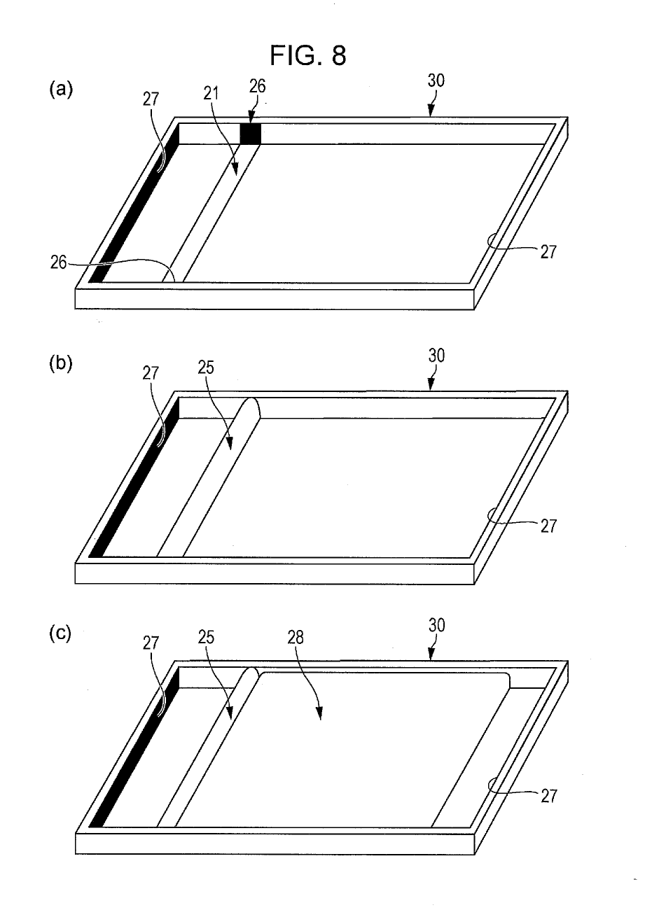

In the case of performing the two-dimensional electrophoresis, the first dimensional electrophoresis may be performed by employing the above-described isoelectric focusing instrument 15, and the second dimensional electrophoresis may be performed by employing another instrument. However, the two-dimensional electrophoresis may be performed by employing one instrument. A two-dimensional electrophoresis instrument 30 adaptable for the two-dimensional electrophoresis will be described below with reference to FIGS. 7 and 8. FIG. 7 is a side sectional view to explain a step of preparing an isoelectric focusing gel and a second dimensional electrophoresis gel according to one embodiment of the present invention. FIG. 8 is a perspective view to explain a step of preparing the isoelectric focusing gel and the second dimensional electrophoresis gel according to the one embodiment of the present invention.

As illustrated in FIGS. 7(a) and 8(a), the two-dimensional electrophoresis instrument (serving also as the isoelectric focusing instrument) 30 includes the groove 21 and pairs of electrodes 26 and 27. Description of portions of the two-dimensional electrophoresis instrument 30 common to those of the isoelectric focusing instrument 15 is omitted.

One practical example of the two-dimensional electrophoresis is described below. First, by performing the above-described gelling step, the isoelectric focusing gel 25 containing the sample dispersed therein is formed in the groove 21 as illustrated in FIGS. 7(b) and 8(b). Then, by performing the isoelectric focusing with the use of the electrodes 26, the sample is separated in the isoelectric focusing gel 25.

Subsequently, a second dimensional electrophoresis gel 28 is disposed adjacent to the isoelectric focusing gel 25. On that occasion, the second dimensional electrophoresis gel 28 having been already prepared may be attached adjacent to the isoelectric focusing gel 25. Alternatively, a solution containing the gel forming material may be applied to a bottom surface of the two-dimensional electrophoresis instrument 30, and the applied solution may be gelled such that the second dimensional electrophoresis gel 28 is formed adjacent to the isoelectric focusing gel 25. It is to be noted that a gel for sodium dodecyl sulfate-polyacrylamide gel electrophoresis (SDS-PAGE) is preferably formed as the second dimensional electrophoresis gel 28.

Then, the second dimensional electrophoresis is performed after disposing the second dimensional electrophoresis gel 28 adjacent to the isoelectric focusing gel 25, as illustrated in FIGS. 7(c) and 8(c). In the two-dimensional electrophoresis instrument 30, the pair of electrodes 27 are disposed to extend in a direction perpendicular to the lengthwise direction of the groove 21. Therefore, the second dimensional electrophoresis can be performed by applying a voltage to the electrodes 27 after introducing a buffer solution for the electrophoresis to the two-dimensional electrophoresis instrument 30. After the sample has been introduced from the isoelectric focusing gel 25 to the second dimensional electrophoresis gel 28, the sample is further separated through the second dimensional electrophoresis. The sample can be separated with a high resolution.

A depth D of the groove 21, denoted in FIG. 7(c), is preferably set to such a value as not impeding the movement of the sample in the isoelectric focusing gel 25 to the second dimensional electrophoresis gel 28. For example, the depth of the groove 21 is preferably 1 mm or less and more preferably 50 μm or more and 150 μm or less. By setting the depth of the groove 21 to fall in the above-described range, it is possible to reduce an amount of the sample that is not moved from the isoelectric focusing gel 25 to the second dimensional electrophoresis gel 28 due to blockade caused by the depth of the groove 21, and to avoid a loss of the sample during the two-dimensional electrophoresis.

Instead of the groove 21, as described above, a region having been subjected to the surface treatment, a convex region, or a region including many concaves and convexes formed therein may be used as the storage region where the sample containing solution 22 is stored. Also in such a case, the depth or the height of the storage region is preferably 1 mm or less and more preferably 50 μm or more and 150 μm or less from the viewpoint of reducing a loss of the sample.

(Substance to be Separated)

The above-described sample may be a substance that is a target to be separated or analyzed through electrophoresis or transfer. For example, a preparation sampled from biological materials, such as an individual organism, a biological fluid, a cell strain, a tissue culture, and a tissue fragment, can be properly used as the sample. In particular, polypeptide or polynucleotide is preferably used.

The present invention is not limited to the above-described embodiments, and it can be variously modified within the scope defined in Claims. Other embodiments obtained by appropriately combining the technical means, modified within the scope of Claims, with each other are also involved in the technical scope of the present invention.

A practical example of the isoelectric focusing using the isoelectric focusing instrument 15 and the isoelectric focusing gel 25 will be described below.

First, an injection molded product made of a PMMA resin and having dimensions of 75 mm length×75 mm width×5 mm height and a thickness of 1 mm was prepared as the isoelectric focusing instrument 15.

The groove 21 was formed in dimensions of 70 mm length×3 mm and a height of several tens micrometers to several hundreds micrometers by masking other regions than a desired region where the groove 21 is to be formed, and by patterning the desired region. Surface treatment was then carried out in a plasma atmosphere by introducing acrylamide or an acrylamide derivative and inert gas.

Next, 100 μL of the sample containing solution 22 mixed with 2 μL of 0.3-μM protein solution was stored in the groove 21. About 40 μL of second solution 24 having a pH gradient was added to the sample containing solution 22 held in the groove 21, thus providing the mixed solution 23.

By gelling the mixed solution 23, the isoelectric focusing gel 25 was obtained as the IPG gel having dimensions of 70 mm length×3 mm width×1 mm thickness and containing the sample.

Next, the isoelectric focusing was performed by applying a voltage of 2 kV to 8 kV to the platinum electrodes disposed in the isoelectric focusing instrument 15. As a result, proteins contained in the isoelectric focusing gel 25 were moved depending on their isoelectric points, whereby those proteins could be separated.

It is to be noted that the numerical values mentioned in the above example regarding the members and the solutions represent one example of the present invention, and those values are optionally selectable without being limited to the above-mentioned ranges.

Besides, the present invention can be expressed as follows. According to one aspect of the present invention, with intent to solve the problems described above, there is provided a two-dimensional electrophoresis kit comprising a casing to contain media, a first medium formed in the casing to perform first dimensional electrophoresis, and a second medium formed in the casing to perform second dimensional electrophoresis and being directly or indirectly contacted with the first medium such that a sample is movable to the second medium from the first medium, wherein the casing is subjected, at a bottom surface thereof contacted with the first medium and the second medium, to surface treatment adapted for (i) supplying, to desired regions of the bottom surface, a first solution to form the first medium and a second solution to form the second medium, and (ii) attaching the first medium and the second medium to the desired regions.

With the features described above, the bottom surface of the casing containing the first medium and the second medium is subjected to the surface treatment adapted for forming the first medium and the second medium. The surface treatment is carried out on the bottom surface of the casing to satisfactorily realize not only supply of the first solution to form the first medium and the second solution to form the second medium to the desired regions of the bottom surface, but also attachment of the first medium and the second medium to the desired regions.

By applying the first solution and the second solution to the bottom surface of the casing having been subjected to the surface treatment as described above, the first solution and the second solution can be spread over the desired regions, and the first medium and the second medium can be formed in the desired regions. Furthermore, the formed first medium and second medium can be attached to the desired regions. It is hence possible to improve both wettability of the bottom surface of the casing with respect to the first solution and the second solution, and adhesion of the formed first medium and second medium with respect to the bottom surface of the casing.

Thus, the first medium and the second medium can be immobilized to the bottom surface of the casing in desired patterns. As a result, connection between the first medium and the second medium on the bottom surface of the casing is strengthened. By employing the two-dimensional electrophoresis kit according to one aspect of the present invention, therefore, the number of sample spots moving from the first medium to the second medium is increased, and the intensity in detection of the spots is improved. In addition, since the number of sample spots moving from the first medium to the second medium is increased, a loss of the sample is reduced.

Preferably, the two-dimensional electrophoresis kit according to one aspect of the present invention further comprises a connecting medium positioned between the first medium and the second medium and contacted with the first medium and the second medium such that the sample can be moved from the first medium to the connecting medium and from the connecting medium to the second medium, wherein the casing is subjected, at a bottom surface thereof contacted with the connecting medium, to surface treatment adapted for supplying, to a desired region of the bottom surface, a connecting solution to form the connecting medium, and attaching the connecting medium to the desired region.

With the features described above, when the connecting medium contacted with the first medium and the second medium is formed between the first medium and the second medium, the connecting medium can be immobilized in a desired pattern to the desired region of the bottom surface of the casing. As a result, connection between the first medium and the connecting medium and connection between the connecting medium and the second medium can be strengthened.

Thus, by employing the two-dimensional electrophoresis kit according to one aspect of the present invention, therefore, the number of sample spots moving from the first medium to the second medium through the connecting medium is increased, and the intensity in detection of the spots is improved. Furthermore, with the provision of the connecting medium, the sample can be more satisfactorily moved from the first medium to the second medium.

Preferably, the two-dimensional electrophoresis kit according to one aspect of the present invention further comprises a first buffer solution storage arranged to supply a buffer solution into the casing from side including the first medium, and a second buffer solution storage arranged to supply a buffer solution into the casing from side including the second medium, wherein the first buffer solution storage, the first medium, the connecting medium, the second medium, and the second buffer solution storage are arrayed parallel to the bottom surface in mentioned order.

With the features described above, by supplying buffer solutions, which are to be used, to the first buffer solution storage and the second buffer solution storage, the buffer solutions adapted for two-dimensional electrophoresis can be supplied to the first medium and the second medium, respectively.

Furthermore, with the features described above, the first buffer solution storage, the first medium, the connecting medium, the second medium, and the second buffer solution storage are arrayed along a flow of process in the two-dimensional electrophoresis, the process including the first dimensional separation, the movement, and the second dimensional separation of the sample. Therefore, the two-dimensional electrophoresis can be performed in a shorter time. Moreover, since the sample having been separated in the first medium can be continuously moved to the second medium inside the casing, the two-dimensional electrophoresis can be performed more readily. In addition, since individual constituent elements are arrayed within the casing parallel to the bottom surface, size reduction of the casing can be realized.

In the two-dimensional electrophoresis kit according to one aspect of the present invention, preferably, the first medium is an immobilized pH gradient gel, the second medium is a separating gel of sodium dodecyl sulfate-polyacrylamide, and the connecting medium is a concentrating gel of sodium dodecyl sulfate-polyacrylamide.

With the features described above, the sample can be moved to the concentrating gel while a separation pattern having been separated through isoelectric focusing in the immobilized pH gel is maintained, and the concentrated sample can be separated through sodium dodecyl sulfate-polyacrylamide electrophoresis (SDS-PAGE) in the separating gel.

Since connection between the immobilized pH gel and the concentrating gel and connection between the concentrating gel and the separating gel, those gels being formed in the casing, are each strengthened by the surface treatment having been carried out on the bottom surface of the casing, the number of sample spots moving from the immobilized pH gradient gel to the separating gel is increased, and the intensity in detection of the spots is improved. Furthermore, since the number of sample spots moving from the immobilized pH gradient gel to the separating gel is increased, a loss of the sample is reduced.

Preferably, the two-dimensional electrophoresis kit according to one aspect of the present invention further comprises a first buffer solution storage arranged to supply a buffer solution into the casing from side including the first medium, and a second buffer solution storage arranged to supply a buffer solution into the casing from side including the second medium, wherein the first buffer solution storage, the first medium, the second medium, and the second buffer solution storage are arrayed parallel to the bottom surface in mentioned order.

With the features described above, by supplying buffer solutions, which are to be used, to the first buffer solution storage and the second buffer solution storage, the buffer solutions adapted for two-dimensional electrophoresis can be supplied to the first medium and the second medium, respectively.

Furthermore, with the features described above, the first buffer solution storage, the first medium, the second medium, and the second buffer solution storage are arrayed along a flow of process in the two-dimensional electrophoresis, the process including the first dimensional separation, the movement, and the second dimensional separation of the sample. Therefore, the two-dimensional electrophoresis can be performed in a shorter time. Moreover, since the sample having been separated in the first medium can be continuously moved to the second medium inside the casing, the two-dimensional electrophoresis can be performed more readily. In addition, since individual constituent elements are arrayed within the casing parallel to the bottom surface, size reduction of the casing can be realized.

In the two-dimensional electrophoresis kit according to one aspect of the present invention, preferably, the first medium is an immobilized pH gradient gel, and the second medium is a gradient gel given with a monomer concentration gradient.

With the features described above, the sample can be moved to the gradient gel given with the monomer concentration gradient while a separation pattern having been separated through isoelectric focusing in the immobilized pH gel is maintained, and the sample can be subjected to the second dimensional electrophoresis in the gradient gel. Sample components having molecular weights distributed over a wide range can be satisfactorily separated by performing the second dimensional electrophoresis in the gradient gel given with the monomer concentration gradient.

Since connection between the immobilized pH gel and the gradient gel both formed in the casing is strengthened by the surface treatment having been carried out on the bottom surface of the casing, the number of sample spots moving from the immobilized pH gradient gel to the gradient gel is increased, and the intensity in detection of the spots is improved. Furthermore, since the number of sample spots moving from the immobilized pH gradient gel to the gradient gel is increased, a loss of the sample is reduced.

In the two-dimensional electrophoresis kit according to one aspect of the present invention, preferably, the surface treatment is selected from a group consisting of nitration treatment, sulfonation treatment, hydrophilic polymer coating treatment, graft polymer coating treatment, microdot forming treatment, nanodot forming treatment, and oxygen plasma treatment.

With the features described above, since a surface treatment film having high hydrophillicity and high adhesion to the corresponding medium can be formed on the bottom surface of the casing, it is possible to improve both wettability of the bottom surface of the casing with respect to the solution, and adhesion of the bottom surface of the casing with respect to the medium. As a result, the medium can be immobilized to the bottom surface of the casing in the desired pattern.

Preferably, the two-dimensional electrophoresis kit according to one aspect of the present invention further comprises voltage applying means to apply voltages to the first medium and the second medium.

With the feature described above, since the media and a device used to perform the two-dimensional electrophoresis are integrally formed into a package, the two-dimensional electrophoresis can be performed more readily.

According to one aspect of the present invention, there is provided a method for manufacturing a two-dimensional electrophoresis kit, the method comprising a surface treatment step of carrying out surface treatment on a bottom surface of a casing, which contains media, in a first region contacted with a first medium for first dimensional electrophoresis, the surface treatment being adapted for supplying a first solution to form the first medium to a desired region, and for attaching the first medium to the desired region, and of carrying out surface treatment on the bottom surface of the casing, which contains the media, in a second region contacted with a second medium for second dimensional electrophoresis, the second medium being directly or indirectly contacted with the first medium such that a sample is movable from the first medium to the second medium, the surface treatment being adapted for supplying a second solution to form the second medium to a desired region, and for attaching the second medium to the desired region, and a forming step of forming the first medium by applying the first solution to the first region after the surface treatment, and of forming the second medium by applying the second solution to the second region after the surface treatment.

Furthermore, according to one aspect of the present invention, there is provided a method for manufacturing a two-dimensional electrophoresis kit, the method comprising a first surface treatment step of carrying out surface treatment on a bottom surface of a casing, which contains media, in a first region contacted with a first medium for first dimensional electrophoresis, the surface treatment being adapted for supplying a first solution to form the first medium to a desired region, and for attaching the first medium to the desired region, a first forming step of forming the first medium by applying the first solution to the first region after the surface treatment, a second surface treatment step of carrying out surface treatment on the bottom surface of the casing, on which the first medium has been formed, in a second region contacted with a second medium for second dimensional electrophoresis, the second medium being directly or indirectly contacted with the first medium such that a sample is movable from the first medium to the second medium, the surface treatment being adapted for supplying a second solution to form the second medium to a desired region, and for attaching the second medium to the desired region, and a second forming step of forming the second medium by applying the second solution to the second region after the surface treatment.

With the features described above, since the surface treatments adapted for forming the first medium and the second medium are carried out on the bottom surface of the casing that contains the first medium and the second medium, connection between the first medium and the second medium both formed on the bottom surface of the casing can be strengthened. By employing the two-dimensional electrophoresis kit manufactured as described above, therefore, the number of sample spots moving from the first medium to the second medium is increased, and the intensity in detection of the spots is improved. Furthermore, since the number of sample spots moving from the first medium to the second medium is increased, a loss of the sample is reduced.

Preferably, the method for manufacturing the two-dimensional electrophoresis kit according to one aspect of the present invention further comprises, after the surface treatment step and before the forming step, a connecting-region surface treatment step of carrying out surface treatment on the bottom surface of the casing in a connecting region, which is positioned between the first region and the second region and which is contacted with a connecting medium held in contact with the first medium and the second medium such that the sample is movable from the first medium to the connecting medium and from the connecting medium to the second medium, the surface treatment being adapted for supplying a connecting solution to form the connecting medium to a desired region, and for attaching the connecting solution to the desired region, and a connecting-medium forming step of forming the connecting medium by applying the connecting solution to the connecting region after the surface treatment.

Preferably, the method for manufacturing the two-dimensional electrophoresis kit according to one aspect of the present invention further comprises, after the second forming step, a connecting-region surface treatment step of carrying out surface treatment on the bottom surface of the casing in a connecting region, which is positioned between the first region and the second region and which is contacted with a connecting medium held in contact with the first medium and the second medium such that the sample is movable from the first medium to the connecting medium and from the connecting medium to the second medium, the surface treatment being adapted for supplying a connecting solution to form the connecting medium to a desired region, and for attaching the connecting solution to the desired region, and a connecting-medium forming step of forming the connecting medium by applying the connecting solution to the connecting region after the surface treatment.

With the features described above, since the surface treatment adapted for forming the connecting medium is carried out on the bottom surface of the casing that contains the connecting medium held in contact with the first medium and the second medium, connection between the first medium and the connecting medium and connection between the connecting medium and the second medium, those media being formed on the bottom surface of the casing, can be strengthened. By employing the two-dimensional electrophoresis kit manufactured as described above, therefore, the number of sample spots moving from the first medium to the second medium through the connecting medium is increased, and the intensity in detection of the spots is improved. Furthermore, since the number of sample spots moving from the first medium to the second medium through the connecting medium is increased, a loss of the sample is reduced.

In the method for manufacturing the two-dimensional electrophoresis kit according to one aspect of the present invention, preferably, the first solution is an immobilized pH gradient solution, the second solution is a separating gel solution of sodium dodecyl sulfate-polyacrylamide, and the connecting solution is a concentrating gel solution of sodium dodecyl sulfate-polyacrylamide.

With the features described above, the two-dimensional electrophoresis kit can be manufactured in which the immobilized pH gel and the separating gel of sodium dodecyl sulfate-polyacrylamide connected to each other through the concentrating gel of sodium dodecyl sulfate-polyacrylamide are contained in the casing.

Connection between the immobilized pH gel and the concentrating gel and connection between the concentrating gel and the separating gel, those gels being formed in the casing, are each strengthened by the surface treatment having been carried out on the bottom surface of the casing. By employing the two-dimensional electrophoresis kit manufactured as described above, therefore, the number of sample spots moving from the immobilized pH gradient gel to the separating gel is increased, and the intensity in detection of the spots is improved. Furthermore, since the number of sample spots moving from the immobilized pH gradient gel to the separating gel is increased, a loss of the sample is reduced.

In the method for manufacturing the two-dimensional electrophoresis kit according to one aspect of the present invention, preferably, the first solution, the second solution, and the connecting solution are applied in the forming step by employing ink jet means.

With the feature described above, the first solution, the second solution, and the connecting solution can be satisfactorily applied to the bottom surface of the casing.

In the method for manufacturing the two-dimensional electrophoresis kit according to one aspect of the present invention, preferably, the first solution is an immobilized pH gradient gel solution, and the second solution is a gradient gel solution given with a monomer concentration gradient.

With the features described above, the two-dimensional electrophoresis kit can be manufactured in which the immobilized pH gel and the gradient gel given with the monomer concentration gradient are connected to each other in the casing. In the case of employing the two-dimensional electrophoresis kit manufactured as described above, since the second dimensional electrophoresis is performed in the gradient gel given with the monomer concentration gradient, sample components having molecular weights distributed over a wide range can be separated satisfactorily.

Connection between the immobilized pH gel and the gradient gel both formed in the casing is strengthened by the surface treatment having been carried out on the bottom surface of the casing. By employing the two-dimensional electrophoresis kit manufactured as described above, therefore, the number of sample spots moving from the immobilized pH gradient gel to the gradient gel is increased, and the intensity in detection of the spots is improved. Furthermore, since the number of sample spots moving from the immobilized pH gradient gel to the gradient gel is increased, a loss of the sample is reduced.

In the method for manufacturing the two-dimensional electrophoresis kit according to one aspect of the present invention, preferably, surface treatment selected from a group consisting of nitration treatment, sulfonation treatment, hydrophilic polymer coating treatment, graft polymer coating treatment, microdot forming treatment, nanodot forming treatment, and oxygen plasma treatment is carried out on the bottom surface of the casing in the surface treatment step.

With the features described above, since a surface treatment film having high hydrophillicity and high adhesion to the corresponding medium can be formed on the bottom surface of the casing, it is possible to improve both wettability of the bottom surface of the casing with respect to the solution, and adhesion of the bottom surface of the casing with respect to the medium. As a result, the medium can be immobilized to the bottom surface of the casing in the desired pattern.

In the method for manufacturing the two-dimensional electrophoresis kit according to one aspect of the present invention, preferably, the first solution contains a sample that is to be separated through second dimensional electrophoresis.

With the features described above, since the first medium is formed by employing the first solution containing the sample, there is no need of introducing the sample into the formed first medium, whereby a time required for introducing the sample in the case of performing the two-dimensional electrophoresis can be shortened. Furthermore, it is possible to reduce a loss of the sample, which may be generated when the sample is introduced to the formed first medium.

According to one aspect of the present invention, there is provided a two-dimensional electrophoresis method wherein two-dimensional electrophoresis is performed by employing any one of the two-dimensional electrophoresis kits described above.

Furthermore, according to one aspect of the present invention, there is provided a two-dimensional electrophoresis method comprising a first surface treatment step of carrying out surface treatment on a bottom surface of a casing, which contains media, in a first region contacted with a first medium for first dimensional electrophoresis, the surface treatment being adapted for supplying a first solution to form the first medium to a desired region, and for attaching the first medium to the desired region, a first forming step of forming the first medium by applying the first solution to the first region after the surface treatment, a first electrophoresis step of performing the first dimensional electrophoresis of a sample in the first medium, a second surface treatment step of, after the first electrophoresis step, carrying out surface treatment on the bottom surface of the casing, on which the first medium has been formed, in a second region contacted with a second medium for second dimensional electrophoresis, the second medium being directly or indirectly contacted with the first medium such that a sample is movable from the first medium to the second medium, the surface treatment being adapted for supplying a second solution to form the second medium to a desired region, and for attaching the second medium to the desired region, a second forming step of forming the second medium by applying the second solution to the second region after the surface treatment, and a second electrophoresis step of performing the second dimensional electrophoresis of the sample in the second medium.

With the features described above, in the two-dimensional electrophoresis kit used for two-dimensional electrophoresis, since the surface treatments adapted for forming the first medium and the second medium are carried out on the bottom surface of the casing that contains the first medium and the second medium, connection between the first medium and the second medium both formed on the bottom surface of the casing is strengthened. By employing that two-dimensional electrophoresis kit in the two-dimensional electrophoresis method according to one aspect of the present invention, therefore, the number of sample spots moving from the first medium to the second medium is increased, and the intensity in detection of the spots is improved. Thus, the two-dimensional electrophoresis can be performed satisfactorily.

According to one aspect of the present invention, there is provided a two-dimensional electrophoresis chip including a casing to contain media, wherein the casing is subjected to surface treatment at a bottom surface thereof, which is contacted with a first medium for first dimensional electrophoresis and a second medium for second dimensional electrophoresis, the second medium being directly or indirectly contacted with the first medium such that a sample is movable to the second medium from the first medium, the surface treatment being adapted for supplying, to desired regions of the bottom surface, a first solution to form the first medium and a second solution to form the second medium, and for attaching the first medium and the second medium to the desired regions.

With the features described above, the surface treatment adapted for forming the first medium and the second medium is carried out on the bottom surface of the casing that contains the first medium and the second medium. Therefore, the first medium and the second medium can be immobilized to the bottom surface of the casing in desired patterns. As a result, connection between the first medium and the second medium on the bottom surface of the casing is strengthened, whereby the number of sample spots moving from the first medium to the second medium is increased, and the intensity in detection of the spots is improved. Furthermore, since the number of sample spots moving from the first medium to the second medium is increased, a loss of the sample can be reduced.

Alternatively, the present invention can be expressed as follows. According to one aspect of the present invention, with intent to solve the problems described above, there is provided a method for preparing an isoelectric focusing gel used to perform isoelectric focusing of a sample, wherein the method includes a gelling step of gelling a sample-containing solution that contains the sample.

With the features described above, since the method includes the gelling step of gelling the sample-containing solution that contains the sample, the isoelectric focusing gel containing the sample can be prepared by gelling the sample-containing solution. In other words, because of preparing the isoelectric focusing gel from the sample-containing solution that contains the sample, a long time is not needed to introduce the sample into a dried gel, and a time required for introducing the sample into the isoelectric focusing gel can be shortened. Furthermore, there is no loss of the sample, which may be generated when the sample is introduced into the dried gel.

Thus, with the features described above, the isoelectric focusing gel capable of increasing the efficiency in introducing the sample can be prepared.

In the method for preparing the isoelectric focusing gel according to one aspect of the present invention, preferably, a second solution containing a gel forming material is added to the sample-containing solution in the gelling step.

With the feature described above, the sample-containing solution can be satisfactorily gelled by adding, to the sample-containing solution, the second solution containing the gel forming material.

In the method for preparing the isoelectric focusing gel according to one aspect of the present invention, preferably, the gel forming material is acrylamide.

With the feature described above, the isoelectric focusing gel can be formed as a polyacrylamide gel, which is widely used as a separating medium for the isoelectric focusing, by adding, to the sample-containing solution, the second solution containing acrylamide.

In the method for preparing the isoelectric focusing gel according to one aspect of the present invention, preferably, a second solution having a pH gradient is added to the sample-containing solution in the gelling step.

With the feature described above, since the second solution having the pH gradient is added to the sample-containing solution, a gel having a pH gradient and being suitable for the isoelectric focusing can be prepared satisfactorily.

In the method for preparing the isoelectric focusing gel according to one aspect of the present invention, preferably, the gelling step includes a storing sub-step of storing the sample-containing solution in an instrument, and an adding sub-step of adding the second solution to the sample-containing solution stored in the instrument.

With the feature described above, the sample-containing solution can be gelled by storing the sample-containing solution in the instrument in the storing sub-step, and by adding the second solution to the sample-containing solution in the adding sub-step. Through the above-described operations, it is possible to satisfactorily prepare the isoelectric focusing gel into which the sample has been introduced.

In the method for preparing the isoelectric focusing gel according to one aspect of the present invention, preferably, the second solution is added in the adding sub-step to the sample-containing solution, which is stored in the instrument, by employing ink jet means.

With the feature described above, the second solution can be satisfactorily added to the sample-containing solution by employing the ink jet means. In particular, in the case of adding a second solution of which characteristics, components, etc. are adjusted depending on an added position, like the second solution having the pH gradient, that type of second solution can be easily added by employing the ink jet means.

According to one aspect of the present invention, there is provided an isoelectric focusing method wherein a sample is subjected to isoelectric focusing in the isoelectric focusing gel prepared by the above-described method for preparing the isoelectric focusing gel.

With the feature described above, since the sample is subjected to the isoelectric focusing by employing the isoelectric focusing gel that contains the sample, the isoelectric focusing can be started at once after the end of the preparation of the isoelectric focusing gel. Therefore, a time required from the start of the preparation of the isoelectric focusing gel to the end of the isoelectric focusing can be shortened.

According to one aspect of the present invention, there is provided an isoelectric focusing gel solution that is gelled to an isoelectric focusing gel in which a sample is subjected to isoelectric focusing, and that is prepared by adding a gel forming material to a sample-containing solution containing the sample.

With the features described above, since the isoelectric focusing gel solution is prepared by adding the gel forming material to the sample-containing solution containing the sample, the isoelectric focusing gel into which the sample has been introduced can be efficiently prepared by gelling the isoelectric focusing gel solution. As a result, it is possible to shorten the time required for introducing the sample to the isoelectric focusing gel, and to reduce a loss of the sample, which may be generated when the sample is introduced into the isoelectric focusing gel.

Thus, with the features described above, the isoelectric focusing gel can be provided which increases efficiency in introducing the sample.

In the isoelectric focusing gel solution according to one aspect of the present invention, preferably, the gel forming material is acrylamide.

With the feature described above, the isoelectric focusing gel can be formed as a polyacrylamide gel, which is widely used as a separating medium for the isoelectric focusing.

Preferably, the isoelectric focusing gel solution according to one aspect of the present invention has a pH gradient.

With the feature described above, the isoelectric focusing gel having the pH gradient and being suitable to perform the isoelectric focusing can be prepared readily.

According to one aspect of the present invention, there is provided an isoelectric focusing instrument including a storage region where the above-described isoelectric focusing gel solution is stored, and electrodes arranged to perform isoelectric focusing of a sample in the isoelectric focusing gel that is formed through gelling of the isoelectric focusing gel solution.

With the features described above, since the isoelectric focusing instrument includes the storage region where the isoelectric focusing gel solution is stored, the isoelectric focusing gel can be readily formed in the storage region. Furthermore, since the isoelectric focusing instrument includes the electrodes for applying a voltage to the isoelectric focusing gel formed in the storage region, the sample can be satisfactorily subjected to the isoelectric focusing.

In the isoelectric focusing instrument according to one aspect of the present invention, preferably, a surface of the storage region is hydrophilic.

With the feature described above, since the surface of the storage region is hydrophilic, it is possible to improve not only wettability of the isoelectric focusing gel with respect to the storage region, but also adhesion of the isoelectric focusing gel with respect to a region where the isoelectric focusing gel is attached.

In the isoelectric focusing instrument according to one aspect of the present invention, preferably, the storage region is formed in a recessed structure, a protruded structure, or a plurality of concave-convex structures.

With the feature described above, since the storage region is formed in the recessed structure, the protruded structure, or the plurality of concave-convex structures, the storage region can be satisfactorily formed in a state capable of preventing the isoelectric focusing gel from flowing out to other regions than the storage region.

### INDUSTRIAL APPLICABILITY

The present invention can be utilized in various types of analyses for biological macromolecules, such as proteins, DNA, and RNA.

Furthermore, the present invention can be utilized in the case of performing the isoelectric focusing to separate biological macromolecules, such as proteins, DNA, and RNA, in accordance with the difference in isoelectric point.

### REFERENCE SIGNS LIST

1, 100 two-dimensional electrophoresis kit
2 electrode (voltage applying means)
3 electrode (voltage applying means)
4 first region
5, 12 second region
6 connecting region
7 first gel (first medium)
8, 13 second gel (second medium)
9 connecting gel (connecting medium)
10 first buffer solution storage
11 second buffer solution storage
15 casing (isoelectric focusing instrument)
20 casing
21 groove (storage region)
22 sample-containing solution
23 mixed solution (isoelectric focusing gel solution)
24 second solution
25 isoelectric focusing gel
26, 27 electrode
28 second dimensional electrophoresis gel
29 ink jet head
30 two-dimensional electrophoresis instrument

1-15. (canceled)

16. A two-dimensional electrophoresis kit comprising:
a first medium for first dimensional electrophoresis;
a second medium for second dimensional electrophoresis;
a casing that contains at least the first medium and the second medium; and
a connecting medium that is contacted with the first medium and the second medium, and that allows movement of a sample to the second medium,
wherein the first medium is formed by supplying, to the casing, a first solution containing a sample on which the first dimensional electrophoresis is to be performed,
the first medium and the second medium are contained close to each other,
the first medium is an immobilized pH gradient gel,
the second medium is a separating gel of sodium dodecyl sulfate-polyacrylamide, and
the connecting medium is a concentrating gel of sodium dodecyl sulfate-polyacrylamide.

17. A two-dimensional electrophoresis kit comprising:
a first medium for first dimensional electrophoresis;
a second medium for second dimensional electrophoresis; and
a casing that contains at least the first medium and the second medium,
wherein the first medium is formed by supplying, to the casing, a first solution containing a sample on which the first dimensional electrophoresis is to be performed,
the first medium and the second medium are contained close to each other,
the first medium is an immobilized pH gradient gel, and
the second medium is a gradient gel given with a monomer concentration gradient.

18. The two-dimensional electrophoresis kit according to claim 16, wherein the casing is subjected to surface treatment that enables at least one of the first medium, the second medium, and the connecting medium to be attached to a desired region of the casing.

19. The two-dimensional electrophoresis kit according to claim 18, wherein the surface treatment is selected from among a group consisting of nitration treatment, sulfonation treatment, hydrophilic polymer coating treatment, graft polymer coating treatment, microdot forming treatment, nanodot forming treatment, and oxygen plasma treatment.

20. The two-dimensional electrophoresis kit according to claim 16, further comprising voltage applying means to apply voltages to the first medium and the second medium.

21. The two-dimensional electrophoresis kit according to claim 17, further comprising voltage applying means to apply voltages to the first medium and the second medium.

22. The two-dimensional electrophoresis kit according to claim 18, further comprising voltage applying means to apply voltages to the first medium and the second medium.

23. The two-dimensional electrophoresis kit according to claim 19, further comprising voltage applying means to apply voltages to the first medium and the second medium.

24. A method for manufacturing a two-dimensional electrophoresis kit, the method comprising at least:
a first step of forming a first medium by supplying, to a casing, a first solution containing a sample on which first dimensional electrophoresis is to be performed;
a second step of supplying, to the casing, a second medium to perform second dimensional electrophoresis and forming the second medium; and
a third step of forming a connecting medium that is contacted with the first medium and the second medium, and that allows movement of the sample to the second medium,
wherein the first step and the second step are executed to form the first medium and the second medium such that the first medium and the second medium are close to each other,
the first solution is an immobilized pH gradient gel solution,
a second solution to form the second medium is a separating gel solution of sodium dodecyl sulfate-polyacrylamide, and
a connecting solution to form the connecting medium is a concentrating gel solution of sodium dodecyl sulfate-polyacrylamide.

25. The method for manufacturing the two-dimensional electrophoresis kit according to claim 24, wherein the first solution, the second solution, and the connecting solution are applied by employing ink jet means.

26. A method for manufacturing a two-dimensional electrophoresis kit, the method comprising at least:
a first step of forming a first medium by supplying, to a casing, a first solution containing a sample on which first dimensional electrophoresis is to be performed; and
a second step of supplying, to the casing, a second medium to perform second dimensional electrophoresis and forming the second medium,
wherein the first step and the second step are executed to form the first medium and the second medium such that the first medium and the second medium are close to each other,
the first solution is an immobilized pH gradient gel solution, and
a second solution to form the second medium is a gradient gel solution.

27. A two-dimensional electrophoresis chip comprising:
a first medium for first dimensional electrophoresis;
a second medium for second dimensional electrophoresis; and
a casing that contains at least the first medium and the second medium,
wherein the first medium is formed by supplying, to the casing, a first solution containing a sample on which the first dimensional electrophoresis is to be performed, and the first medium and the second medium are contained close to each other.
